(19) United States
(12) Patent Application Publication
(10) Pub. No.: US 2016/0139578 A1
(43) Pub. Date: May 19, 2016

(54) METHODS AND DEVICES FOR CONTROLLING ACTIVE POWER FLOW IN A THREE-PHASE MODULAR MULTILEVEL CONVERTER

(71) Applicant: ABB TECHNOLOGY LTD, Zürich (CH)

(72) Inventors: Jean-Philippe HASLER, Västerås (SE); Jan KHEIR, Västerås (SE)

(73) Assignee: ABB TECHNOLOGY LTD, Zürich (CH)

(21) Appl. No.: 14/897,116

(22) PCT Filed: Jun. 12, 2013
(86) PCT No.: PCT/EP2013/062084

§ 371 Date: Dec. 9, 2015

(51) Int. Cl. G05B 19/042; G05B 19/10; H02J 3/18

(52) U.S. Cl. CPC G05B 19/042; H02J 3/18; G05B 19/106; G05B 2219/2639

(57) ABSTRACT

The invention relates to methods and devices for controlling unbalanced active power flow in a three-phase modular multilevel converter 20. The converter 20 comprises a first and second converter 4, 5 both comprising three phase legs arranged in a wye-connection. The first and second converters 4, 5 are interconnected in a double-wye connection, and their neutral paths are independently floating. The method 200 comprises: detecting an active power flow in the phase legs; determining a zero-sequence voltage, the determination providing magnitude and phase of the zero-sequence voltage; re-computing the magnitude of the zero-sequence voltage while keeping the phase of the zero-sequence voltage fixed, the magnitude being re-computed with the requirement that the resulting voltage over the phase legs is smaller than or equal to a maximum allowed leg voltage, the re-computed magnitude and the phase giving a re-computed zero-sequence voltage; imposing the re-computed zero-sequence voltage on the neutral point of the first and second converters, thereby reducing the active power flow determining remaining active power based on the re-computed magnitude of the zero-sequence voltage; determining a DC current giving a product with a DC voltage of the first and second converters 4, 5 that will counteract remaining active power; and imposing the DC current on the phase legs.

### FIELD OF THE INVENTION

The technology disclosed herein relates generally to the field of power exchange in electric power networks, and in particular to methods and devices for controlling active power flow in three-phase converters.

### BACKGROUND OF THE INVENTION

Modular multilevel converters (MMCs) may be connected to an electrical power network (denoted power network in the following) in order to stabilize the power network and reduce disturbances therein or in order to enable reactive power compensation for the power network.

The MMCs have advantages over other converter topologies, in particular the modularity of the design, but also increased switching frequency which reduces the harmonics on the AC side. However, the modularity comes at a cost: increased complexity of the converter topology requires more sophisticated controlling.

A main difference introduced with MMCs is that they comprise several DC capacitors, and thus several DC voltages that have to be controlled. For example, for a MMC-based static synchronous compensator (STATCOM) operating under normal conditions, i.e. balanced phase voltages and currents, the MMC-based STATCOM provides only reactive power. However, under unbalanced conditions, the MMC-based STATCOM will supply/absorb unbalanced active power. That is, each phase of the MMC-based STATCOM will supply/absorb a different amount of active power. Such flow of active power changes the DC capacitor voltages, which is unsustainable.

The above problem has been addressed in different ways. For an MMC-based STATCOM comprising a single wye-coupled converter supplying positive sequence currents to the power network having unbalanced voltages, it is possible to impose a negative-sequence current that will cancel the flow of active power. This solution has a drawback in that the negative sequence currents increase the unbalance condition in the power network. Furthermore, this solution imposes a restriction on the operating range of the MMC-based STATCOM. Indeed, it is not possible to provide any wanted positive sequence currents and negative sequence currents simultaneously as they are related by the need to cancel active power flow.

Another solution is to impose a zero-sequence voltage on the neutral point of the MMC-based STATCOM. This solution does not create additional unbalance in the power network, and is flexible in the sense that positive-sequence currents and negative sequence currents can be chosen independently to some degree. It can be shown that it is not always possible to find a finite zero-sequence voltage that will cancel the flow of active power if both a negative sequence current and a positive sequence current need to be supplied. Furthermore, this solution requires that the MMC-based STATCOM is rated for a much higher voltage than the nominal power network voltage.

If the MMC-based STATCOM has a zero-sequence current path, it is also possible to use a zero-sequence current. This solution does not require the MMC-based STATCOM to be overrated from a voltage perspective; however, it does require a higher current rating. It can also be shown for this solution that it is not always possible to find a finite zero-sequence current that will cancel the flow of active power if both a positive sequence voltage and a negative sequence voltage are present in the power network. This solution also relies on the existence of a zero-sequence current path which requires the use of additional components, in particular grounding transformer, neutral connected to the neutral of a wye coupled three-phase AC filter.

In the case of a double-wye coupled converter, it is possible to use DC currents to cancel the active power flow. Due to the fact that this solution relies on DC quantities, it can be shown that there always exists a finite solution that will cancel the active power flow. However, it also requires a MMC-based STATCOM with a higher current rating. Furthermore, the double-wye coupled MMC-based STATCOM requires more leg reactors and DC capacitors than a single wye-coupled converter.

From the above it is clear that there is a need for improved methods for controlling unbalanced conditions in a power network.

### SUMMARY OF THE INVENTION

An object of the invention is to provide methods and devices for overcoming or at least alleviating the above mentioned drawbacks of the prior art.

The object is according to a first aspect achieved by a method performed in a device for controlling unbalanced active power flow in a three-phase modular multilevel converter. The modular multilevel converter comprises a first converter comprising three phase legs arranged in a wye-connection and a second converter comprising three phase legs connected in a wye-connection. The first converter and the second converter are interconnected in a double-wye connection. The first converter and the second converter neutral paths are independently floating. The method comprises: detecting an active power flow in the phase legs; determining a zero-sequence voltage, the determination providing magnitude and phase of the zero-sequence voltage; re-computing the magnitude of the zero-sequence voltage while keeping the phase of the zero-sequence voltage fixed, the magnitude being re-computed with the requirement that the resulting voltage over the phase legs is smaller than or equal to a maximum allowed leg voltage, the re-computed magnitude and the phase giving a re-computed zero-sequence voltage; imposing the re-computed zero-sequence voltage on the neutral point of the first and second converters, thereby reducing the active power flow; determining remaining active power based on the re-computed magnitude of the zero-sequence voltage; determining a DC current giving a product with a DC voltage of the first and second converters that will counteract the remaining active power; and imposing the DC current on the phase legs, thereby eliminating the active power flow.

The method provides an improved operation of a converter during unbalanced conditions compared to prior art. The converter is rendered flexible in that it may act as an ideal generator, i.e. it can simultaneously provide positive sequence capacitive currents to support the positive sequence voltage and negative sequence inductive currents to suppress the negative sequence voltage. Furthermore, the method enables the reduction of the voltage and/or current rating of a converter for a given size, which in turn reduces the cost of the converter itself. The method is further versatile in that it provides improved control means for converters used in different applications. For example, in railway applications, where a negative sequence current is required to balance an unbalanced load or in High Voltage Direct Current (HVDC) applications, e.g. when an HVDC terminal is used as a STATCOM.

The object is according to a second aspect achieved by a control device for controlling unbalanced active power flow in a three-phase modular multilevel converter. The modular multilevel converter comprises a first converter comprising three phase legs arranged in a wye-connection and a second converter comprising three phase legs connected in a wye-connection. The first converter and the second converter are interconnected in a double-wye connection. The first converter and the second converter neutral paths are independently floating. The control device comprises a processor and memory, the memory containing instructions executable by the processor, whereby the control device is operative to: detect an active power flow in the phase legs; determine a zero-sequence voltage, the determination providing magnitude and phase of the zero-sequence voltage; re-compute the magnitude of the zero-sequence voltage while keeping the phase of the zero-sequence voltage fixed, the magnitude being re-computed with the requirement that the resulting voltage over the phase legs is smaller than or equal to a maximum allowed leg voltage, the re-computed magnitude and the phase giving a re-computed zero-sequence voltage; impose the re-computed zero-sequence voltage on the neutral point of the first and second converters, thereby reducing the active power flow; determine remaining active power based on the re-computed magnitude of the zero-sequence voltage; determine, a DC current giving a product with a DC voltage of the first and second converters that will counteract the remaining active power, and impose the DC current on the phase legs, thereby eliminating the active power flow. Advantages corresponding to the above are achieved.

The object is according to a third aspect achieved by a method performed in a device for controlling unbalanced active power flow in a three-phase modular multilevel converter. The modular multilevel converter comprises a first converter comprising three phase legs arranged in a wye-connection and a second converter comprising three phase legs connected in a wye-connection. The first converter and the second converter are interconnected in a double-wye connection. The first converter and the second converter neutral paths are connected to ground. The method comprises: detecting an active power flow in the phase legs; determining a zero-sequence current, the determination providing magnitude and phase of the zero-sequence current; re-computing the magnitude of the zero-sequence current while keeping the phase of the zero-sequence current fixed, the magnitude being re-computed with the requirement that the resulting currents in the phase legs is smaller than or equal to a maximum allowed leg current, the re-computed magnitude and the phase giving a re-computed zero-sequence current; imposing the re-computed zero-sequence current on the first and second converters, thereby reducing the active power flow; determining remaining active power based on the re-computed magnitude of the zero-sequence current; determining, a DC current giving a product with a DC voltage of the first and second converters that will counteract the remaining active power; and imposing the DC current on the phase legs, thereby eliminating the remaining active power flow.

The object is according to a fourth aspect achieved by a device for controlling unbalanced active power flow in a three-phase modular multilevel converter. The modular multilevel converter comprises a first converter comprising three phase legs arranged in a wye-connection and a second converter comprising three phase legs connected in a wye-connection. The first converter and the second converter are interconnected in a double-wye connection. The first converter and the second converter neutral paths are grounded. The device comprises a processor and memory, the memory containing instructions executable by the processor, whereby the device is operative to: detect an active power flow in the phase legs; determine a zero-sequence current, the determination providing magnitude and phase of the zero-sequence current; re-compute the magnitude of the zero-sequence current while keeping the phase of the zero-sequence current fixed, the magnitude being re-computed with the requirement that the resulting currents in the phase legs is smaller than or equal to a maximum allowed leg current, the re-computed magnitude and the phase giving a re-computed zero-sequence current; impose the re-computed zero-sequence current on the first and second converters, thereby reducing the active power flow; determine remaining active power based on the re-computed magnitude of the zero-sequence current; determine, a DC current giving a product with a DC voltage of the first and second converters that will counteract the remaining active power; and impose the DC current on the phase legs, thereby eliminating the remaining active power flow.

The object is according to a fifth aspect achieved by a method performed in a device for controlling unbalanced active power flow in a three-phase modular multilevel converter. The modular multilevel converter comprises a first converter comprising three phase legs arranged in a wye-connection. The first converter neutral path is connected to ground through a variable impedance. The method comprises: detecting an active power flow in the phase legs; determining active power \vec{P} unbalance terms by

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] , ,$$

wherein \vec{V}₁, \vec{V}₂ are power network 1 positive and negative sequence voltages, respectively, and \vec{I}₁, \vec{I}₂ are modular multilevel converter positive sequence currents; determining a zero-sequence voltage to be the largest allowed voltage that ensures that all phase leg voltages are below a maximum voltage, the total unbalance then being determined by:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] ;$$

determining a zero-sequence current to be the largest allowed current that ensures that all phase leg currents are below a maximum current, whereby total unbalance is given by:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] + Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ] ;$$

determining a required zero-sequence impedance to be

$${Z}_{0} ∠ζ = \frac{1}{3} \frac{ {V}_{0} {∠ϕ}_{v , 0}}{ {I}_{0} {∠ϕ}_{i , 0}} ;$$

determine, a DC current giving a product with a DC voltage of the first converter that will counteract any remaining active power;
imposing the DC current on the phase legs, thereby eliminating any remaining active power flow.

The object is according to a sixth aspect achieved by a device for controlling unbalanced active power flow in a three-phase modular multilevel converter. The modular multilevel converter comprises a first converter comprising three phase legs arranged in a wye-connection. The first converter neutral path is connected to ground through a variable impedance. The device comprises a processor and memory, the memory containing instructions executable by the processor, whereby the device is operative to:
detect an active power flow in the phase legs;
determine active power \vec{P} unbalance terms by

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] , ,$$

wherein \vec{V}₁, \vec{V}₂ are power network 1 positive and negative sequence voltages, respectively, and \vec{I}₁, \vec{I}₂ are modular multilevel converter positive sequence currents;
determine a zero-sequence voltage to be the largest allowed voltage that ensures that all phase leg A_{U}, B_{U}, C_{U} voltages are below a maximum voltage V_{ac max}, the total unbalance then being determined by:

$$\vec{P} = Re [ {\vec{V}}_{1} {\vec{I}}_{2}^{*} [ \begin{matrix}\begin{matrix}1 \\ α\end{matrix} \\ {α}^{2}\end{matrix} ] ] + Re [ {\vec{V}}_{2} {\vec{I}}_{1}^{*} [ \begin{matrix}\begin{matrix}1 \\ {α}^{2}\end{matrix} \\ α\end{matrix} ] ] + Re [ {\vec{V}}_{0} {\vec{I}}_{1}^{*} [ \begin{matrix}\begin{matrix}1 \\ α\end{matrix} \\ {α}^{2}\end{matrix} ] ] + Re [ {\vec{V}}_{0} {\vec{I}}_{2}^{*} [ \begin{matrix}\begin{matrix}1 \\ {α}^{2}\end{matrix} \\ α\end{matrix} ] ]$$

determine a zero-sequence current I₀ to be the largest allowed current that ensures that all phase leg currents are below a maximum current I_{ac max}, whereby total unbalance is given by:

$$\vec{P} = Re [ {\vec{V}}_{1} {\vec{I}}_{2}^{*} [ \begin{matrix}\begin{matrix}1 \\ α\end{matrix} \\ {α}^{2}\end{matrix} ] ] + Re [ {\vec{V}}_{2} {\vec{I}}_{1}^{*} [ \begin{matrix}\begin{matrix}1 \\ {α}^{2}\end{matrix} \\ α\end{matrix} ] ] + Re [ {\vec{V}}_{0} {\vec{I}}_{1}^{*} [ \begin{matrix}\begin{matrix}1 \\ α\end{matrix} \\ {α}^{2}\end{matrix} ] ] + Re [ {\vec{V}}_{0} {\vec{I}}_{2}^{*} [ \begin{matrix}\begin{matrix}1 \\ {α}^{2}\end{matrix} \\ α\end{matrix} ] ] + Re [ {\vec{V}}_{1} {\vec{I}}_{0}^{*} [ \begin{matrix}\begin{matrix}1 \\ {α}^{2}\end{matrix} \\ α\end{matrix} ] ] + Re [ {\vec{V}}_{2} {\vec{I}}_{0}^{*} [ \begin{matrix}\begin{matrix}1 \\ α\end{matrix} \\ {α}^{2}\end{matrix} ] ]$$

determine and setting a required zero-sequence impedance to be

$${Z}_{0} ∠ζ = \frac{1}{3} \frac{{V}_{0} {∠ϕ}_{v , 0}}{{I}_{0} {∠ϕ}_{i , 0}}$$

determine a DC current giving a product with a DC voltage of the first converter that will counteract any remaining active power;
impose the DC current on the phase legs, thereby eliminating any remaining active power flow.

Further features and advantages of the present teachings will become clear upon reading the following description and the accompanying drawings.

### BRIEF DESCRIPTION OF THE DRAWINGS

FIG. 1 illustrates schematically an environment in which embodiments of the invention may be implemented.

FIG. 2 illustrates a modular multilevel converter which may be controlled in accordance with various embodiments of the invention.

FIG. 3 illustrates a flow chart over steps of an embodiment of a method of the invention.

FIG. 4 illustrates a modular multilevel converter which may be controlled in accordance with another embodiment of the invention.

FIG. 5 illustrates a flow chart over steps of an embodiment of a method of the invention.

FIG. 6 illustrates a modular multilevel converter which may be controlled in accordance with still another embodiment of the invention.

FIG. 7 illustrates a modular multilevel converter which may be controlled in accordance with still another embodiment of the invention.

FIG. 8 illustrates a flow chart over steps of an embodiment of a method of the invention.

### DETAILED DESCRIPTION OF EMBODIMENTS

In the following description, for purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail. Same reference numerals refer to same or similar elements throughout the description.

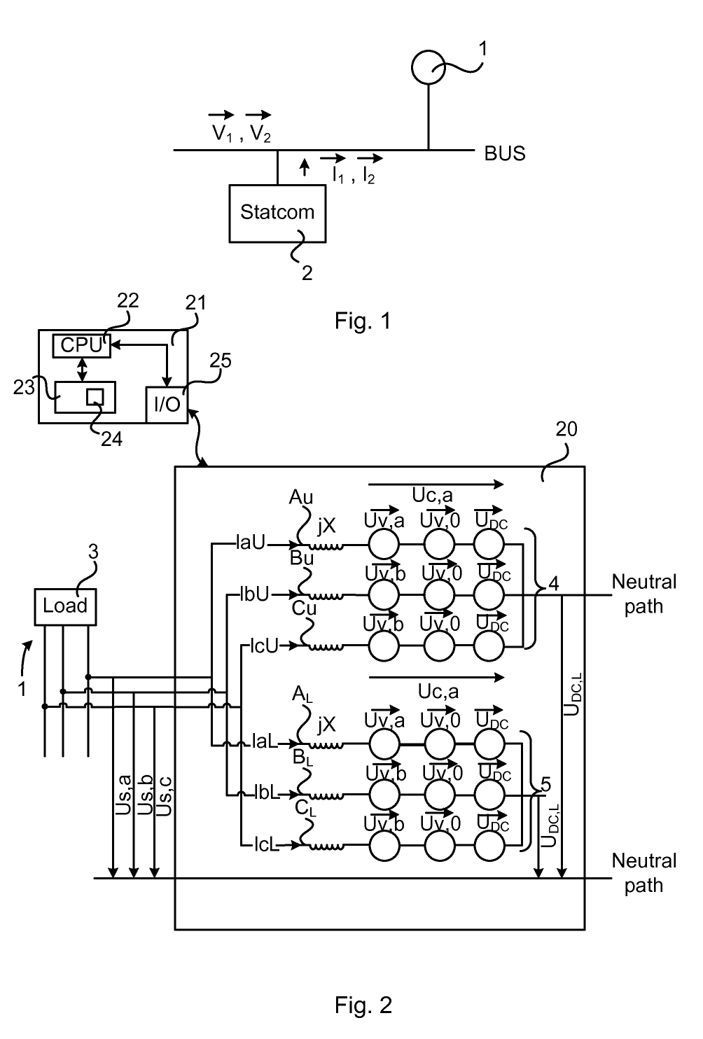

FIG. 1 illustrates schematically an environment in which embodiments of the invention may be implemented. A modular multilevel converter (MMC), and in particular a MMC-based static synchronous compensator (STATCOM) 2 is connected to an electrical power network 1 bus.

In the FIG. 1, \vec{V}₁, \vec{V}₂ denote power network 1 voltages, in particular positive and negative sequence voltages, respectively, and the bus voltage V_{BUS} is V₁+V₂. Under balanced conditions, the STATCOM 2, which is supplying positive sequence currents \vec{I}₁, \vec{I}₂, should only supply/absorb reactive power. However, in the general case the power network 1 voltages are unbalanced, i.e. composed of both positive and negative sequence voltages and the STATCOM 2 supplies both positive and negative sequence currents. It is then not possible to guarantee zero active power flow (i.e. only reactive power) in all three phases simultaneously. The teachings of the present application address particularly this problem of undesired unbalanced active power flow.

FIG. 2 illustrates the MMC-based STATCOM 2, which may be controlled in accordance with various embodiments of the invention. The illustrated STATCOM 20 is made up of two converters, a first converter 4, in the following denoted an upper converter 4 and a second converter 5, in the following denoted a lower converter 5 which are interconnected in a double-wye connection.

The upper converter 4 and the lower converter 5 each comprise a voltage source converter having three phase legs A_{U}, B_{U}, C_{U}, and A_{L}, B_{L}, C_{L}, respectively The phase legs A_{U}, B_{U}, C_{U}; A_{L}, B_{L}, C_{L} are arranged in a wye-connection (also denoted star-connection). Each phase leg (in the following also denoted leg) comprises one or more series-connected converter cells (not illustrated). Such converter cells are also denoted switching cells and the particular layout of the converter cells is not important for the present teachings. For example, each converter cell may comprise four valves connected in an H-bridge arrangement with a capacitor unit (typically denoted full-bridge converter cell). Each valve in turn may comprise a transistor switch, such as an IGBT (Insulated Gate Bipolar Transistor), having a free-wheeling diode connected in parallel thereto. It is noted that other semiconductor devices could be used, e.g. gate turn-off thyristors (GTO) or Integrated Gate-Commutated Thyristors (IGCT). The converter cells could alternatively be half-bridge converter cells, and it is noted that yet other converter topologies could benefit from the present teachings. As mentioned in the background section, varying voltages over the capacitor units (in the following also denoted DC capacitors) of the converter cells due to active power flow is undesirable.

The above-described converter cells are not illustrated in FIG. 2, but the voltage created by the converter cells can be decomposed conceptually into its AC sequence components and DC components. The circles in the FIG. 2 can be seen as representing the AC and DC components of the voltage generated by the series-connected converter cells. In particular, U_{v,a} is the AC component voltage of leg voltage in phase a; U_{v,0} is the zero sequence component of the leg voltage in phase a; U_{DC} is the DC component of the leg voltage in phase a; and finally U_{c,a} is the total converter leg voltage in phase a. The sum of U_{v,a}, U_{v,a} and U_{v,a} is the sum of positive and/or negative sequence components of the leg voltage in phase a. Corresponding denotations are used for all the phase leg voltages of both the upper converter 4 as well as of the lower converter 5.

The phases A_{U}, B_{U}, C_{U}; A_{L}, B_{L}, C_{L} are connected to the electrical power network 1, in particular a three-phase power network 1, in the following denoted power network 1. The power network 1 is connected to a load 3, e.g. any industrial load or residential load. The phases A_{U}, B_{U}, C_{U}; A_{L}, B_{L}, C_{L} of the STATCOM 20 is connected to the power network 1 via a respective phase reactor, indicated in the FIG. 2 as jX. There may be further devices, commonly used, but which are not illustrated in the FIG. 2, e.g. coupling transformers, filter devices etc.

As mentioned earlier, under balanced network conditions, the STATCOM 20 supplying positive sequence currents should only supply/absorb reactive power. In order for this to be true, the following must hold:

$$\begin{matrix}[ \begin{matrix}{\vec{V}}_{a} \\ {\vec{V}}_{b} \\ {\vec{V}}_{c}\end{matrix} ] = [ \begin{matrix}1 \\ {α}^{2} \\ α\end{matrix} ] {\vec{V}}_{1} {e}^{jω t} & ( 1 ) \\ [ \begin{matrix}{\vec{I}}_{a} \\ {\vec{I}}_{b} \\ {\vec{I}}_{c}\end{matrix} ] = [ \begin{matrix}1 \\ {α}^{2} \\ α\end{matrix} ] {\vec{I}}_{1} {e}^{jω t} & ( 2 )\end{matrix}$$

where

$${\vec{V}}_{1} = {V}_{1} {∠ϕ}_{1} and {\vec{I}}_{1} = {I}_{1} ∠ ( {ϕ}_{1} \pm \frac{π}{2} )$$

However, as also mentioned earlier, in the general case where the power network 1 voltages are unbalanced, i.e. are composed of both positive and negative sequence voltages, and where the STATCOM 20 supplies both positive and negative sequence currents, it is not possible to guarantee zero active power flow in all three phases simultaneously. Indeed, expressing power network 1 voltages and STATCOM 2 currents in their symmetrical components:

Upper and Lower Phase Leg Voltages:

$$\begin{matrix}{\vec{V}}_{U} = [ \begin{matrix}1 \\ {α}^{2} \\ α\end{matrix} ] {\vec{V}}_{1} {e}^{j ω t} + [ \begin{matrix}1 \\ α \\ {α}^{2}\end{matrix} ] {\vec{V}}_{2} {e}^{j ω t} + \frac{{V}_{DC}}{2} [ \begin{matrix}1 \\ 1 \\ 1\end{matrix} ] & ( 3 ) \\ {\vec{V}}_{L} = [ \begin{matrix}1 \\ {α}^{2} \\ α\end{matrix} ] {\vec{V}}_{1} {e}^{j ω t} + [ \begin{matrix}1 \\ α \\ {α}^{2}\end{matrix} ] {\vec{V}}_{2} {e}^{j ω t} - \frac{{V}_{DC}}{2} [ \begin{matrix}1 \\ 1 \\ 1\end{matrix} ] & ( 4 )\end{matrix}$$

Upper and Lower Phase Leg Currents:

$$\begin{matrix}{\vec{I}}_{U} = [ \begin{matrix}1 \\ {α}^{2} \\ α\end{matrix} ] {\vec{I}}_{1} {e}^{j ω t} + [ \begin{matrix}1 \\ α \\ {α}^{2}\end{matrix} ] {\vec{I}}_{2} {e}^{j ω t} & ( 5 ) \\ {\vec{I}}_{L} = [ \begin{matrix}1 \\ {α}^{2} \\ α\end{matrix} ] {\vec{I}}_{1} {e}^{j ω t} + [ \begin{matrix}1 \\ α \\ {α}^{2}\end{matrix} ] {\vec{I}}_{2} {e}^{j ω t} & ( 6 )\end{matrix}$$

we can express the active power flow in all three phases as:

$$\begin{matrix}{\vec{P}}_{U} = Re ( {\vec{V}}_{U} \cdot {\vec{I}}_{U}^{*} ) = Re [ ( [ \begin{matrix}1 \\ {α}^{2} \\ α\end{matrix} ] {\vec{V}}_{1} {e}^{j ω t} + [ \begin{matrix}1 \\ α \\ {α}^{2}\end{matrix} ] {\vec{V}}_{2} {e}^{j ωt} + \frac{{V}_{DC}}{2} [ \begin{matrix}1 \\ 1 \\ 1\end{matrix} ] ) \cdot {( [ \begin{matrix}1 \\ {α}^{2} \\ α\end{matrix} ] {\vec{I}}_{1} {e}^{j ω t} + [ \begin{matrix}1 \\ {α}^{2} \\ α\end{matrix} ] {\vec{I}}_{2} {e}^{jω t} )}^{*} ] & ( 7 ) \\ \begin{matrix}{\vec{P}}_{L} = Re ( {\vec{V}}_{L} \cdot {\vec{I}}_{L}^{*} ) = Re [ ( [ \begin{matrix}1 \\ {α}^{2} \\ α\end{matrix} ] {\vec{V}}_{1} {e}^{j ω t} + [ \begin{matrix}1 \\ α \\ {α}^{2}\end{matrix} ] {\vec{V}}_{2} {e}^{j ωt} - \frac{{V}_{DC}}{2} [ \begin{matrix}1 \\ 1 \\ 1\end{matrix} ] ) \cdot {( [ \begin{matrix}1 \\ {α}^{2} \\ α\end{matrix} ] {\vec{I}}_{1} {e}^{j ω t} + [ \begin{matrix}1 \\ {α}^{2} \\ α\end{matrix} ] {\vec{I}}_{2} {e}^{jω t} )}^{*} ] & \end{matrix} & ( 8 )\end{matrix}$$

The products of DC voltage and AC currents give an average of zero. Therefore, these terms are of no interest as they do not represent net absorbed energy or net generated energy. Also, the product of positive sequence voltage and positive sequence current as well as the product of negative sequence voltage and negative sequence current give only reactive power. Therefore, the only terms of interest are:

$$\begin{matrix}{\vec{P}}_{U} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] & ( 9 ) \\ {\vec{P}}_{L} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] & ( 10 )\end{matrix}$$

A problem of having a non-zero flow in active power in the STATCOM 20 phase legs A_{U}, B_{U}, C_{U}; A_{L}, B_{L}, C_{L} is that the only storage of energy in the STATCOM 20 phase legs is in the DC capacitors of each converter cell. This means that a positive flow of active power in a given phase leg of the upper/lower converter 4, 5 will charge/discharge the capacitors in that leg and thus increase/decrease their DC voltages, while a negative flow of active power in a given phase leg of the upper/lower converter 4, 5 will have the opposite effect on the DC voltages. This is of course unacceptable.

Note that because both the upper and lower converters 4, 5 share the total current equally, the active power flows in the upper converter 4 and the lower converter 5 are identical. To simplify the rest of this detailed description, only the calculations for the upper converter 4 will be shown. The calculations for the lower converter 5 may be done using the same equations.

The active power flow may be compensated for in different ways. In the following, the use of DC currents (I_{DC} Method), the use zero-sequence voltage (V₀ Method), and the use of zero-sequence current path (I₀ Method) will be described.

### I_{DC} Method

This method consists of imposing a DC current on the upper converter 4 phase legs A_{U}, B_{U}, C_{U}. The DC voltages of the upper and lower converters 4, 5 are of the same magnitude but of opposite polarity, and since the active power flows are equal, a DC current of same amplitude but of opposite polarity is needed in the upper and lower converter legs A_{U}, B_{U}, C_{U}, A_{L}, B_{L}, C_{L} of the same phase in order to correct the situation. Furthermore, by imposing the condition that the sum of the DC currents in all three phases is equal to zero, it can be ensured that no DC current will flow out of the upper and lower converters 4, 5 and into the power network 1. The idea is then to choose a DC current that will give a product with the DC voltage that will counteract the active power flow caused be the unbalanced operating conditions. Therefore, we can define:

$$\begin{matrix}( \frac{{V}_{DC}}{2} [ \begin{matrix}1 \\ 1 \\ 1\end{matrix} ] ) \cdot [ \begin{matrix}{I}_{DC , a} \\ {I}_{DC , b} \\ {I}_{DC , c}\end{matrix} ] = - Re [ {\vec{V}}_{1} {\vec{I}}_{2}^{*} [ \begin{matrix}1 \\ α \\ {α}^{2}\end{matrix} ] ] - Re [ {\vec{V}}_{1} {\vec{I}}_{2}^{*} [ \begin{matrix}1 \\ {α}^{2} \\ α\end{matrix} ] ] \\ and & ( 11 ) \\ [ \begin{matrix}{I}_{DC , a} \\ {I}_{DC , b} \\ {I}_{DC , c}\end{matrix} ] = - \frac{2}{{V}_{DC}} Re [ {\vec{V}}_{1} {\vec{I}}_{2}^{*} [ \begin{matrix}1 \\ α \\ {α}^{2}\end{matrix} ] ] - \frac{2}{{V}_{DC}} Re [ {\vec{V}}_{2} {\vec{I}}_{1}^{*} [ \begin{matrix}1 \\ {α}^{2} \\ α\end{matrix} ] ] & ( 12 )\end{matrix}$$

### V₀ Method

This method is applicable for a STATCOM which has independently floating DC buses (see FIG. 2). The second method consists of imposing a zero sequence voltage on the neutral point of the upper and lower converters which will counteract the effect of the unbalanced operation conditions. With the zero-sequence voltage, the leg voltages become:

$$\begin{matrix}{\vec{V}}_{U} = [ \begin{matrix}1 \\ 1 \\ 1\end{matrix} ] {\vec{V}}_{0} {e}^{j ω t} + [ \begin{matrix}1 \\ {α}^{2} \\ α\end{matrix} ] {\vec{V}}_{1} {e}^{j ω t} + [ \begin{matrix}1 \\ α \\ {α}^{2}\end{matrix} ] {\vec{V}}_{2} {e}^{j ω t} + \frac{{V}_{DC}}{2} [ \begin{matrix}1 \\ 1 \\ 1\end{matrix} ] & ( 13 ) \\ {\vec{V}}_{L} = [ \begin{matrix}1 \\ 1 \\ 1\end{matrix} ] {\vec{V}}_{0} {e}^{j ω t} + [ \begin{matrix}1 \\ {α}^{2} \\ α\end{matrix} ] {\vec{V}}_{1} {e}^{j ω t} + [ \begin{matrix}1 \\ α \\ {α}^{2}\end{matrix} ] {\vec{V}}_{2} {e}^{j ω t} - \frac{{V}_{DC}}{2} [ \begin{matrix}1 \\ 1 \\ 1\end{matrix} ] & ( 14 )\end{matrix}$$

while the phase leg currents remain as before. The active power balance (in the upper converter 4) is then:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] + Re [ {\vec{V}}_{2} {\vec{I}}_{1}^{*} [ \begin{matrix}1 \\ {α}^{2} \\ α\end{matrix} ] ] \qquad ( 15 )$$

By setting the following condition:

$$Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] = - Re [ {\vec{V}}_{1} {\vec{I}}_{2}^{*} [ \begin{matrix}1 \\ α \\ {α}^{2}\end{matrix} ] ] - Re [ {\vec{V}}_{2} {\vec{I}}_{1}^{*} [ \begin{matrix}1 \\ {α}^{2} \\ α\end{matrix} ] ] \qquad ( 16 )$$

it is then possible to solve for \vec{V}₀. Indeed, since there are two unknowns (magnitude and phase of the zero sequence voltage) two of the three equations above can be solved simultaneously to obtain \vec{V}₀. However, it can be shown that for φ₁-φ₂=0 or π, the first equation becomes degenerate, for

$${ϕ}_{1} - {ϕ}_{2} = - \frac{2 π}{3}$$

the second one becomes degenerate and for

$${ϕ}_{1} - {ϕ}_{2} = \frac{2 π}{3}$$

the third one becomes degenerate. Therefore, in order to have a robust system, all three combinations of two equations must be solved simultaneously. In that way, at least two of the three solutions will be correct at all times. Solving the first and second equations together, the following solution is obtained:

$$\begin{matrix}{V}_{0} = \frac{( {V}_{1} {I}_{2} + {V}_{2} {I}_{1} ) sin ( {ϕ}_{1} - {ϕ}_{2} )}{{I}_{1} sin ( {ϕ}_{0} - {ϕ}_{1} ) - {I}_{2} sin ( {ϕ}_{0} - {ϕ}_{2} )} & ( 17 ) \\ {ϕ}_{0} = - arctan ( \frac{{I}_{2} sin ( - 3 {ϕ}_{1} + 3 {ϕ}_{2} )}{{I}_{1} - {I}_{2} cos ( - 3 {ϕ}_{1} + 3 {ϕ}_{2} )} ) + 2 {ϕ}_{1} - {ϕ}_{2} & ( 18 )\end{matrix}$$

### I₀ Method

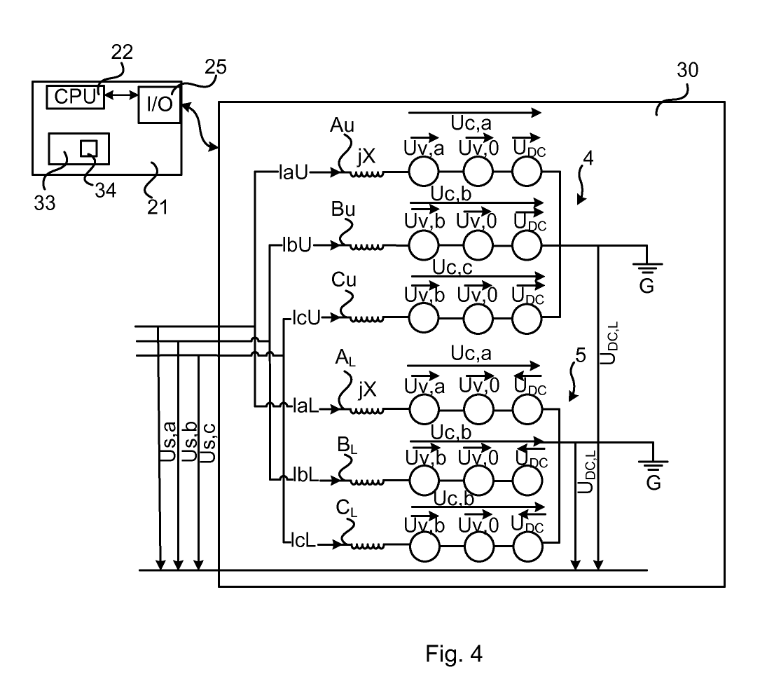

This method is applicable for a STATCOM which has a path for an AC zero-sequence current to flow (see FIG. 4). One exemplary implementation is to have three-phase wye connected AC notch filter tuned to the fundamental frequency with their neutrals connected to the two DC buses. Another exemplary implementation is to have the neutrals connected to the AC grid through DC capacitors and grounding transformers. The method then consists of imposing a zero sequence current reference on the upper and lower converters which will counteract the effect of the unbalanced operation conditions. With the zero-sequence current, the leg currents become:

$$\begin{matrix}{\vec{I}}_{U} = [ \begin{matrix}1 \\ 1 \\ 1\end{matrix} ] {\vec{I}}_{0} {e}^{j ω t} + [ \begin{matrix}1 \\ {α}^{2} \\ α\end{matrix} ] {\vec{I}}_{1} {e}^{j ω t} + [ \begin{matrix}1 \\ α \\ {α}^{2}\end{matrix} ] {\vec{I}}_{2} {e}^{j ω t} & ( 19 ) \\ {\vec{I}}_{L} = [ \begin{matrix}1 \\ 1 \\ 1\end{matrix} ] {\vec{I}}_{0} {e}^{j ω t} + [ \begin{matrix}1 \\ {α}^{2} \\ α\end{matrix} ] {\vec{I}}_{1} {e}^{j ω t} + [ \begin{matrix}1 \\ α \\ {α}^{2}\end{matrix} ] {\vec{I}}_{2} {e}^{j ω t} & ( 20 )\end{matrix}$$

The active power unbalance (in the upper converter 4) is then:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ] \qquad ( 21 )$$

By setting the following condition:

$$Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ] = - Re [ {\vec{V}}_{1} {\vec{I}}_{2}^{*} [ \begin{matrix}1 \\ α \\ {α}^{2}\end{matrix} ] ] - Re [ {\vec{V}}_{2} {\vec{I}}_{1}^{*} [ \begin{matrix}1 \\ {α}^{2} \\ α\end{matrix} ] ] \qquad ( 22 )$$

it is then possible to solve for \vec{I}₀. Indeed, since there are two unknowns (magnitude and phase of the zero sequence current) two of the three equations above can be solved simultaneously to obtain \vec{I}₀. However, it can be shown that for φ₁-φ₂=0 or π, the first equation becomes degenerated, for

$${ϕ}_{1} - {ϕ}_{2} = - \frac{2 π}{3}$$

the second one becomes degenerate and for

$${ϕ}_{1} - {ϕ}_{2} = \frac{2 π}{3}$$

the third one becomes degenerate. Therefore, in order to have a robust system, all three combinations of two equations must be solved simultaneously. In that way, at least two of the three solutions will be correct at all times. Solving the first and second equations together, the following solution is obtained:

$$\begin{matrix}{I}_{0} = \frac{( {V}_{1} {I}_{2} + {V}_{2} {I}_{1} ) sin ( {ϕ}_{1} - {ϕ}_{2} )}{{V}_{1} cos ( {ϕ}_{1} - {ϕ}_{0} ) + {V}_{2} cos ( {ϕ}_{2} - {ϕ}_{0} )} & ( 23 ) \\ {ϕ}_{0} = - arctan ( \frac{{V}_{1} + {V}_{2} cos ( - 3 {ϕ}_{1} + 3 {ϕ}_{2} )}{{V}_{2} sin ( - 3 {ϕ}_{1} + 3 {ϕ}_{2} )} ) + 2 {ϕ}_{1} - {ϕ}_{2} & ( 24 )\end{matrix}$$

A first embodiment of the present invention is described in the following with reference to FIG. 2. In this embodiment, the upper and lower converter 4, 5 neutral paths are independently floating. A control device 21 is arranged to control the converter 20 (the STATCOM). The control device 21 comprises processing circuitry, in the following denoted processor 22, memory 23 comprising instructions executable by the processor 23, whereby the control device 20 is operative to perform various functions for controlling the converter 20. The control device 21 further comprises input devices and output devices, I/O unit in the following and in the FIG. 2 illustrated at reference numeral 25. The I/O unit 25 is configured to receive various electrical parameter measurements from different devices (not illustrated) located at different locations within the power network 1. The I/O unit 25 is further configured to receive and transmit data from/to the converter 20, thus controlling the functions of the converter 20.

### Using Zero-Sequence Voltage Method and DC Current Method:

In the embodiment to be described the DC current method I_{DC} and the zero-sequence voltage method V₀ are used in combination. The leg voltages and currents needed to balance the active power flow are minimized while the desired reactive power output from the STATCOM is obtained. Basically, the zero-sequence voltage method V₀ is first used to remove part of the active power flow, and then the DC current method I_{DC} is applied to remove any remaining active power flow.

First, the zero-sequence voltage V₀ is computed in accordance with the above described calculations for the zero-sequence voltage method (i.e. equations (13)-(18)). Next, the angle of the zero-sequence voltage is kept fixed and the amplitude is recomputed so that the resulting leg voltages are smaller than or equal to the maximum allowed leg voltage V_{ac max}. That is:

$${\vec{V}}_{U} = [ \begin{matrix}1 \\ 1 \\ 1\end{matrix} ] {\vec{V}}_{0} {e}^{j ω t} + [ \begin{matrix}1 \\ {α}^{2} \\ α\end{matrix} ] {\vec{V}}_{1} {e}^{j ω t} + [ \begin{matrix}1 \\ α \\ {α}^{2}\end{matrix} ] {\vec{V}}_{2} {e}^{j ω t} \qquad ( 25 )$$

Then:

\vec{V}ₐ=1·V₀e^{jφ}^{₀}+1·V₁e^{jφ}^{₁}+1·V₂e^{jφ}^{₂} (26)

\vec{V}_{b}=1·V₀e^{jφ}^{₀}+α²·V₁e^{jφ}^{₁}+α·V₂e^{jφ}^{₂} (27)

\vec{V}_{c}=1·V₀e^{jφ}^{₀}+α·V₁e^{jφ}^{₁}+α²·V₂e^{jφ}^{₂} (28)

Setting the inequality condition mentioned above and solving for each phase (only phase a shown below) one gets:

|Vₐ|=|V₀e^{jφ}^{₀}+V₁e^{jφ}^{₁}+V₂e^{jφ}^{₂}|≦V_{ac max} (29)

and then solving for the amplitude of V₀ one gets:

V₀≦(V₁ cos(φ₀φ₁)+V₂ cos(φ₀−φ₂))± (30)

$$\sqrt{\begin{matrix}{( {V}_{1} cos ( {ϕ}_{0} - {ϕ}_{1} ) + {V}_{2} cos ( {ϕ}_{0} - {ϕ}_{2} ) )}^{2} - \\ ( {V}_{1}^{2} + {V}_{2}^{2} + 2 {V}_{1} {V}_{2} cos ( {ϕ}_{1} - {ϕ}_{2} ) - {V}_{ac max}^{2} )\end{matrix}} \qquad ( 31 )$$

Negative solutions for V₀ are discarded since the phase of V₀ is already decided, and the smallest solution from all three phases is taken as the largest allowed V₀ for unbalanced active power flow balancing. The unbalanced power terms are therefore:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] \qquad ( 32 )$$

In equation (32), the first terms are partially cancelled by the two last terms, although not completely, since the amplitude of V₀ is limited in order not to exceed the voltage limit of the valve legs. The rest of the cancellation of the unbalance power terms is then performed using the DC current method I_{DC}. The DC currents are found to be:

$$\begin{matrix}( \frac{{V}_{DC}}{2} [ \begin{matrix}1 \\ 1 \\ 1\end{matrix} ] ) \cdot [ \begin{matrix}{I}_{DC , a} \\ {I}_{DC , b} \\ {I}_{DC , c}\end{matrix} ] = \begin{matrix}- Re [ {\vec{V}}_{1} {\vec{I}}_{2}^{*} [ \begin{matrix}1 \\ α \\ {α}^{2}\end{matrix} ] ] - \\ Re [ {\vec{V}}_{2} {\vec{I}}_{1}^{*} [ \begin{matrix}1 \\ {α}^{2} \\ α\end{matrix} ] ] - \\ Re [ {\vec{V}}_{0} {\vec{I}}_{1}^{*} [ \begin{matrix}1 \\ α \\ {α}^{2}\end{matrix} ] ] - \\ Re [ {\vec{V}}_{0} {\vec{I}}_{2}^{*} [ \begin{matrix}1 \\ {α}^{2} \\ α\end{matrix} ] ]\end{matrix} & ( 33 ) \\ [ \begin{matrix}{I}_{DC , a} \\ {I}_{DC , b} \\ {I}_{DC , c}\end{matrix} ] = - \frac{2}{{V}_{DC}} ( \begin{matrix}Re [ {\vec{V}}_{1} {\vec{I}}_{2}^{*} [ \begin{matrix}1 \\ α \\ {α}^{2}\end{matrix} ] ] + \\ Re [ {\vec{V}}_{2} {\vec{I}}_{1}^{*} [ \begin{matrix}1 \\ {α}^{2} \\ α\end{matrix} ] ] + \\ Re [ {\vec{V}}_{0} {\vec{I}}_{1}^{*} [ \begin{matrix}1 \\ α \\ {α}^{2}\end{matrix} ] ] + \\ Re [ {\vec{V}}_{0} {\vec{I}}_{2}^{*} [ \begin{matrix}1 \\ {α}^{2} \\ α\end{matrix} ] ]\end{matrix} ) & ( 34 )\end{matrix}$$

These DC currents are then lower or equal to the necessary DC currents needed to balance the flow of unbalanced active power without the zero-sequence method voltage V₀ method.

In the following a comparison is given of the performance of the DC current method, the zero-sequence voltage method and the embodiment using a combination of both these methods.

Considering an unbalanced network condition such that:

$${\vec{V}}_{1} = \frac{2}{3} ∠0$$

$${\vec{V}}_{2} = \frac{1}{3} ∠π$$

And the STATCOM output is

$${\vec{I}}_{1} = 0.7 ∠ \frac{π}{2}$$

$${\vec{I}}_{2} = 0.3 ∠ \frac{π}{2}$$

such that the STATCOM is seen as a capacitor for the positive sequence, and as an inductor for the negative sequence. Assuming a DC voltage of 1 pu, and calculating the required DC currents if only that method is used, one gets:

$$\begin{matrix}[ \begin{matrix}{I}_{DC , a} \\ {I}_{DC , b} \\ {I}_{DC , c}\end{matrix} ] = - \frac{2}{{V}_{DC}} Re [ {\vec{V}}_{1} {\vec{I}}_{2}^{*} [ \begin{matrix}1 \\ α \\ {α}^{2}\end{matrix} ] ] - \frac{2}{{V}_{DC}} Re [ {\vec{V}}_{2} {\vec{I}}_{1}^{*} [ \begin{matrix}1 \\ {α}^{2} \\ α\end{matrix} ] ] \\ = [ \begin{matrix}0 \\ - 0.75 \\ 0.75\end{matrix} ]\end{matrix}$$

and the AC three-phase quantities are:

\vec{V}ₐ=0.33∠0° \vec{I}ₐ=1.00∠90°

\vec{V}_{b}=0.88∠−100.9° \vec{I}_{b}=0.61∠−55.3°

\vec{V}_{c}=0.88∠100.9° \vec{I}_{c}=0.61∠−124.7°

Alternatively, using only the zero-sequence method, one gets:

$${ϕ}_{0} = - arctan ( \frac{{I}_{2} sin ( - 3 {ϕ}_{1} + 3 {ϕ}_{2} )}{{I}_{1} - {I}_{2} cos ( - 3 {ϕ}_{1} + 3 {ϕ}_{2} )} ) + 2 {ϕ}_{1} - {ϕ}_{2} = 180 °$$

$${V}_{0} = \frac{( {V}_{1} {I}_{2} + {V}_{2} {I}_{1} ) sin ( {ϕ}_{1} - {ϕ}_{2} + a )}{{I}_{1} sin ( {ϕ}_{0} - {ϕ}_{1} + a ) - {I}_{2} sin ( {ϕ}_{0} - {ϕ}_{2} - a )} = 1.08$$

(note: φ₁-φ₂=−π therefore the equation for V₀ in phase b is used with

$$a = \frac{2 π}{3} )$$

which results in the following three-phase AC quantities:

\vec{V}ₐ=0.75∠180° \vec{I}ₐ=1.00∠90°

\vec{V}_{b}=1.52∠−145.3° \vec{I}_{b}=0.61∠−55.3°

\vec{V}_{c}=1.52∠145.3° \vec{I}_{c}=0.61∠−124.7°

Finally, if both the DC current method and the zero-sequence method are used with V_{ac max}=1 pu:

$${ϕ}_{0} = - arctan ( \frac{{I}_{2} sin ( - 3 {ϕ}_{1} + 3 {ϕ}_{2} )}{{I}_{1} - {I}_{2} cos ( - 3 {ϕ}_{1} + 3 {ϕ}_{2} )} ) + 2 {ϕ}_{1} - {ϕ}_{2} = 180 °$$

Solving for the maximum allowed amplitude of V₀ as described earlier, for each phase, one gets:

V₀_{_}ₗᵢₘ_{_}ₐ=1.33, −0.67

V₀_{_}ₗᵢₘ_{_}_{b}=0.33, −0.67

V₀_{_}ₗᵢₘ_{_}_{c}=0.33, −0.67

The negative solutions are discarded and the smallest solution from all three phases is chosen as the maximum limit on V₀. Therefore, one gets:

$${\vec{V}}_{0} = \frac{1}{3} ∠180°$$

Which results in the following three-phase AC quantities:

\vec{V}ₐ=0∠0° Iₐ=1.00∠90°

\vec{V}_{b}=1.00∠120° I_{b}=0.61∠−55.3°

\vec{V}_{c}=1.00∠120° I_{c}=0.61∠−124.7°

The necessary DC currents are then computed as:

$$\begin{matrix}[ \begin{matrix}{I}_{DC , a} \\ {I}_{DC , b} \\ {I}_{DC , c}\end{matrix} ] = - \frac{2}{{V}_{DC}} ( \begin{matrix}Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + \\ Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ]\end{matrix} ) \\ = [ \begin{matrix}0 \\ - 0.52 \\ 0.52\end{matrix} ]\end{matrix}$$

These new DC currents are approximately 30% lower than those necessary if no zero-sequence voltage is used.

| | Zero-sequence | |
|---|---|---|
| DC current method | voltage method | Combined method |
| \vec{V}ₐ = 0.33∠0° | \vec{V}ₐ = 0.75∠180° | \vec{V}ₐ = 0∠0° |
| \vec{V}_{b} = 0.88∠−100.9° | \vec{V}_{b} = 1.52∠−145.3° | \vec{V}_{b} = 1.00∠−120° |
| \vec{V}_{c} = 0.88∠100.9° | \vec{V}_{c} = 1.52∠145.3° | \vec{V}_{c} = 1.00∠120° |
| \vec{I}ₐ = 1.00∠90° | \vec{I}ₐ = 1.00∠90° | \vec{I}ₐ = 1.00∠90° |
| \vec{I}_{b} = 0.61∠−55.3° | \vec{I}_{b} = 0.61∠−55.3° | \vec{I}_{b} = 0.61∠−55.3° |
| \vec{I}_{c} = 0.61∠−124.7° | \vec{I}_{c} = 0.61∠−124.7° | \vec{I}_{c} = 0.61∠−124.7° |
| \vec{V}₀ = 0∠0° | \vec{V}₀ = 1.08∠180° | \vec{V}₀ = 0.33∠180° |
| $[ \begin{matrix}{I}_{DC , a} \\ {I}_{DC , b} \\ {I}_{DC , c}\end{matrix} ] = [ \begin{matrix}0 \\ - 0.75 \\ 0.75\end{matrix} ]$ | $[ \begin{matrix}{I}_{DC , a} \\ {I}_{DC , b} \\ {I}_{DC , c}\end{matrix} ] = [ \begin{matrix}0 \\ 0 \\ 0\end{matrix} ]$ | $[ \begin{matrix}{I}_{DC , a} \\ {I}_{DC , b} \\ {I}_{DC , c}\end{matrix} ] = [ \begin{matrix}0 \\ - 0.52 \\ 0.52\end{matrix} ]$ |

It is noted that it would not be possible to apply the zero-sequence current method for this example because the required zero-sequence current would be in phase with the current in phase a, which is already at it's acceptable limit.

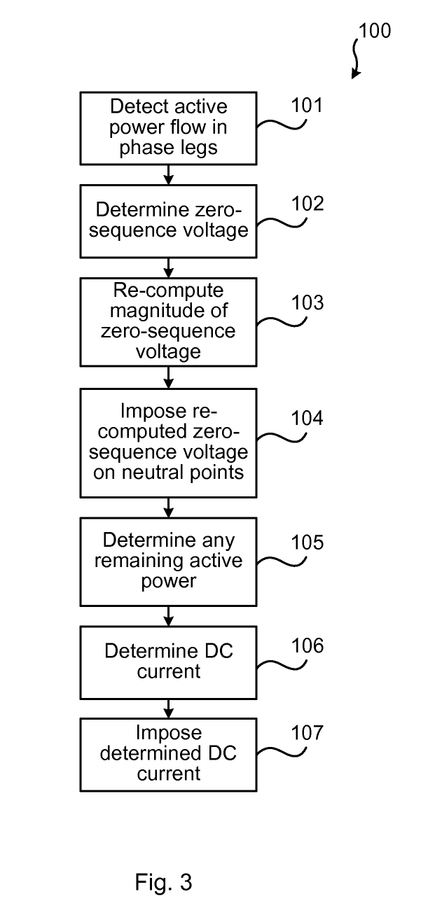

FIG. 3 illustrates in a flow chart embodiments of a method based on the above description. The method 100 can be implemented and performed in a device 21 for controlling unbalanced active power flow in a three-phase modular multilevel converter 20. The converter 20 comprises an upper converter 4, comprising three phase legs A_{U}, B_{U}, C_{U} arranged in a wye-connection, and a lower converter 5 comprising three phase legs A_{L}, B_{L}, C_{L} connected in a wye-connection. The upper converter 4 and the lower converter 5 are interconnected in a double-wye connection. The upper converter 4 and the lower converter 5 neutral paths are arranged independently floating.

The method 100 comprises detecting 101 an active power flow in the phase legs A_{U}, B_{U}, C_{U}; A_{L}, B_{L}, C_{L}. This detections can be done in any conventional manner that are used for detecting that network voltages are unbalanced, i.e. that they are composed of both positive and negative sequence voltages. Within the power network 1 there will typically be a number of measuring means by means of which various electrical parameters can be obtained. The control device 21 is configured to receive various such parameter values and from this it may be configured to detect if an unbalance condition is fulfilled and thus detected.

Next, a zero-sequence voltage is determined 102, the determination providing magnitude V₀ and phase φ₀ of the zero-sequence voltage. For this step, refer to equations (13), (14), (15), (16), (17) and (18) and related description.

Next, the magnitude V₀ of the zero-sequence voltage re-computed 103 while keeping the phase φ₀ of the zero-sequence voltage fixed. The magnitude is re-computed with the requirement that the resulting voltage over the phase legs A_{U}, B_{U}, C_{U}; A_{L}, B_{L}, C_{L} is smaller than or equal to a maximum allowed leg voltage V_{ac max}. The re-computed magnitude and the phase φ₀ gives a re-computed zero-sequence voltage. For this step, refer to equations (25), (26), (27), (28), (29), (30) and (31) and related description.

Next, the re-computed zero-sequence voltage is imposed 104 on the neutral point of the upper and lower converters 4,5. The active power flow in the converter 20 is thereby reduced.

Next, the remaining active power is determined 105 based on the re-computed magnitude of the zero-sequence voltage. For this step, refer to equation (32) and related description.

Next, a DC current is determined 106 giving a product with a DC voltage of the first and lower converters 4, 5 that will counteract the remaining active power, and in particular counteract and eliminate the active power flow caused by the unbalanced operating conditions. For this step, refer to equations (11), (12) and (33), (34) and the respective related descriptions.

Finally, the DC current is imposed 107 on the phase legs (A_{U}, B_{U}, C_{U}; A_{L}, B_{L}, C_{L}), thereby eliminating the remaining active power flow.

In a variation of the above method 100, a battery is connected between the neutral path of the upper converter 4 and the neutral path of the lower converter 5.

In another variation of the above method 100, the determining of the zero-sequence voltage 102 comprises using the equations (13), (14), (15), (16), (17) and (18).

In another variation of the above method 100, the re-computing 103 of the magnitude V₀ of zero-sequence voltage the comprises using equations (25), (26), (27), (28), (29), (30) and (31).

With reference to FIG. 2, the invention also encompasses the control device 21 configured to control unbalanced active power flow in the three-phase modular multilevel converter 20. The converter 20 has already been described and comprises an upper converter 4, comprising three phase legs A_{U}, B_{U}, C_{U} arranged in a wye-connection, and a lower converter 5 comprising three phase legs A_{L}, B_{L}, C_{L} connected in a wye-connection. The upper converter and the lower converter 4, 5 are interconnected in a double-wye connection, and the upper converter 4 and the lower converter 5 neutral paths are independently floating. The control device 21 comprises a processor 22 and memory 23, the memory 23 containing instructions executable by the processor 22, whereby the control device 21 is operative to perform the methods as described. In a particular embodiment, the control device 21 is operative to: detect an active power flow in the phase legs A_{U}, B_{U}, C_{U}; A_{L}, B_{L}, C_{L}; determine a zero-sequence voltage, the determination providing magnitude V₀ and phase φ₀ of the zero-sequence voltage; re-compute the magnitude V₀ of the zero-sequence voltage while keeping the phase φ₀ of the zero-sequence voltage fixed, the magnitude being re-computed with the requirement that the resulting voltage over the phase legs A_{U}, B_{U}, C_{U}; A_{L}, B_{L}, C_{L} is smaller than or equal to a maximum allowed leg voltage V_{ac max}, the re-computed magnitude and the phase φ₀ giving a re-computed zero-sequence voltage; impose the re-computed zero-sequence voltage on the neutral point of the upper and lower converters, thereby reducing the active power flow; determine remaining active power based on the re-computed magnitude of the zero-sequence voltage; determine, a DC current giving a product with a DC voltage of the upper and lower converters 4, 5 that will counteract the remaining active power; and impose the DC current on the phase legs A_{U}, B_{U}, C_{U}; A_{L}, B_{L}, C_{L}, thereby eliminating the active power flow.

With reference still to FIG. 2, the invention also encompasses a computer program 24 for controlling unbalanced active power flow in a three-phase modular multilevel converter 20. The computer program 24 comprises computer program code, or instructions, which when run on the control device 21, and in particular the processor 22 thereof, causes the control device 21 to perform the methods as described.

A computer program product 23 is also provided comprising the computer program 24 and computer readable means on which the computer program 24 is stored. The computer program product 23 may be any combination of read and write memory (RAM) or read only memory (ROM). The computer program product 23 may also comprise persistent storage, which for example can be any single one or combination of magnetic memory, optical memory or solid state memory.

With reference now to FIG. 4, another embodiment of the invention will be described next. FIG. 4 illustrates a modular multilevel converter which is identical to FIG. 2, with the exception of the upper and lower converter 4, 5 neutral paths being connected to ground G. The description provided in relation to FIG. 2 is in all other ways applicable also to FIG. 4, and will not be repeated.

Further, the control device 21 described in relation to FIG. 2 may be configured to control the converter 30 in accordance with the methods to be described below, which configuration can be adapted by using same or different memory 23, 33 however comprising different set of instructions executable by the processor 23 compared to the instructions of the previous embodiments. The description of control device 21 given in relation to FIG. 2 is applicable in all other ways also for the embodiment of FIG. 4.

### Using Zero-Sequence Current Method and DC Current Method:

In the embodiment to be described next the DC current method I_{DC} and the zero-sequence current method I₀ are used in combination. The leg voltages and currents needed to balance the active power flow are minimized while the desired reactive power output from the STATCOM is obtained with a zero-sequence current path. Basically, the zero-sequence current method I₀ is first used to remove part of the active power flow, and then the DC current method I_{DC} is applied to remove any remaining active power flow.

First, the zero-sequence current is computed in accordance with the above described calculations for the zero-sequence current method I₀ (i.e. equations (19)-(24)). Next, the angle of the zero-sequence current is kept fixed, and the amplitude is recomputed so that the resulting leg currents are smaller than or equal to the maximum allowed leg currents, I_{ac max}. That is:

Starting from:

$${\vec{I}}_{U} = [ \begin{matrix}1 \\ 1 \\ 1\end{matrix} ] {\vec{I}}_{0} {e}^{j ω t} + [ \begin{matrix}1 \\ {α}^{2} \\ α\end{matrix} ] {\vec{I}}_{1} {e}^{j ω t} + [ \begin{matrix}1 \\ α \\ {α}^{2}\end{matrix} ] {\vec{I}}_{2} {e}^{j ω t} \qquad ( 35 )$$

we get:

\vec{I}ₐ=1·I₀e^{jφ}^{₀}+1·I₁e^{jφ}^{₁}+1·I₂e^{jφ}^{₂} (36)

\vec{I}_{b}=1·I₀e^{jφ}^{₀}α²·I₁e^{jφ}^{₁}+α·I₂e^{jφ}^{₂} (37)

\vec{I}_{c}=1·I₀e^{jφ}^{₀}+α·I₁e^{jφ}^{₁}+α²·I₂e^{jφ}^{₂} (38)

Setting the above mentioned inequality condition and solving for each phase (again, only one phase, namely phase a, is shown here) we get:

|\vec{I}ₐ|=|I₀e^{jφ}^{₀}+I₁e^{jφ}^{₁}+I₂e^{jφ}^{₂}|≦I_{ac max} (39)

and solving for the amplitude we get:

I₀≦−(I₁ cos(φ₀−φ₁)+I₂ cos(φ₀−φ₂))± (40)

$$\sqrt{\begin{matrix}( {I}_{1} cos ( {ϕ}_{0} - {ϕ}_{1} ) + {( {I}_{2} cos ( {ϕ}_{0} - {ϕ}_{2} ) )}^{2} - {I}_{1}^{2} + {I}_{2}^{2} + \\ 2 {I}_{1} {I}_{2} cos ( {ϕ}_{1} - {ϕ}_{2} ) - {{I}_{ac max}}^{2} )\end{matrix}} \qquad ( 41 )$$

Negative solutions for I₀ are discarded since the phase of I₀ is already decided, and the smallest solution from all three phases is taken as the largest allowed I₀ for unbalanced active power flow balancing. The unbalanced power terms are therefore:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ {α}^{ } \\ {α}^{2}\end{matrix} ] ] \qquad ( 42 )$$

In the above equation the two first terms are partially cancelled by the two last terms, although not completely, since the amplitude of I₀ is limited in order not to exceed the voltage limit on the valve legs. The rest of the cancellation of the unbalanced power terms is then done using the DC current method I_{DC}. The DC currents are found to be:

$$\begin{matrix}( \frac{{V}_{DC}}{2} [ \begin{matrix}1 \\ 1 \\ 1\end{matrix} ] ) \cdot [ \begin{matrix}{I}_{DC , a} \\ {I}_{DC , b} \\ {I}_{DC , c}\end{matrix} ] = - Re [ {\vec{V}}_{1} {\vec{I}}_{2}^{*} [ \begin{matrix}1 \\ α \\ {α}^{2}\end{matrix} ] ] - Re [ {\vec{V}}_{2} {\vec{I}}_{1}^{*} [ \begin{matrix}1 \\ {α}^{2} \\ α\end{matrix} ] ] - Re [ {\vec{V}}_{1} {\vec{I}}_{0}^{*} [ \begin{matrix}1 \\ {α}^{2} \\ α \end{matrix} ] ] - Re [ {\vec{V}}_{2} {\vec{I}}_{0}^{*} [ \begin{matrix}1 \\ α \\ {α}^{2}\end{matrix} ] ] & ( 43 ) \\ [ \begin{matrix}{I}_{DC , a} \\ {I}_{DC , b} \\ {I}_{DC , c}\end{matrix} ] = - \frac{2}{{V}_{DC}} ( Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ] ) & ( 44 )\end{matrix}$$

These DC currents are then lower than or equal to the necessary DC currents needed to balance the flow of unbalanced active power without the use of the zero-sequence current method I₀.

In the following a comparison is given of the performance of the DC current method, the zero-sequence current method and the embodiment using a combination of both these methods.

Consider an unbalanced network condition such that:

$${\vec{V}}_{1} = \frac{2}{3} ∠0$$

$${\vec{V}}_{2} = \frac{1}{3} ∠0$$

The STATCOM output is:

$${\vec{I}}_{1} = 0.7 ∠ \frac{π}{2}$$

$${\vec{I}}_{2} = 0.3 ∠ - \frac{π}{2}$$

Such that the STATCOM is seen as a capacitor for the positive sequence and as an inductor for the negative sequence. Assuming a DC voltage of 1 pu and calculating the required DC currents if only that method is used, one gets:

$$[ \begin{matrix}{I}_{DC , a} \\ {I}_{DC , b} \\ {I}_{DC , c}\end{matrix} ] = - \frac{2}{{V}_{DC}} Re [ {\vec{V}}_{1} {\vec{I}}_{2}^{*} [ \begin{matrix}1 \\ α \\ {α}^{2}\end{matrix} ] ] - \frac{2}{{V}_{DC}} Re [ {\vec{V}}_{2} {\vec{I}}_{1}^{*} [ \begin{matrix}1 \\ {α}^{2} \\ {α}^{ }\end{matrix} ] ] = [ \begin{matrix}0 \\ 0.75 \\ - 0.75\end{matrix} ]$$

And the AC three-phase quantities are:

\vec{V}ₐ=1.00∠0° Iₐ=0.40∠90°

\vec{V}_{b}=0.58∠−150° \vec{I}_{b}=0.89∠−13.0°

\vec{V}_{c}=0.58∠150° I_{c}=0.89∠−167.0°

Alternatively, using only the zero-sequence current method, one gets:

$${ϕ}_{0} = - arctan ( \frac{{V}_{1} + {V}_{2} cos ( - 3 {ϕ}_{1} + 3 {ϕ}_{2} )}{{V}_{2} sin ( - 3 {ϕ}_{1} + 3 {ϕ}_{2} )} ) + 2 {ϕ}_{1} - {ϕ}_{2} = - 90 °$$

$${I}_{0} = \frac{( {V}_{1} {I}_{2} + {V}_{2} {I}_{1} ) sin ( {ϕ}_{1} - {ϕ}_{2} )}{{V}_{1} cos ( {ϕ}_{1} - {ϕ}_{0} ) + {V}_{2} cos ( {ϕ}_{2} - {ϕ}_{0} )} = 1.3$$

(note: φ₁−φ₂=−π, therefor, equation for 10 in phase b is used with

$$a = \frac{2 π}{3} ) ,$$

which results in the following three-phase AC quantities:

\vec{V}ₐ=1.00∠0° Iₐ=0.90∠90°

\vec{V}_{b}=0.58∠−150° \vec{I}_{b}=1.73∠−60°

\vec{V}_{c}=0.58∠150° I_{c}=1.73∠−120°

Finally if both the DC current method I_{DC} and the zero-sequence method are used with I_{ac max}=1 pu:

$${ϕ}_{0} = - arctan ( \frac{{V}_{1} + {V}_{2} cos ( - 3 {ϕ}_{1} + 3 {ϕ}_{2} )}{{V}_{2} sin ( - 3 {ϕ}_{1} + 3 {ϕ}_{2} )} ) + 2 {ϕ}_{1} - {ϕ}_{2} = - 90 °$$

Solving for the maximum allowed amplitude of I₀ as described for each phase, one gets:

I₀_{_}ₗᵢₘ_{_}ₐ=1.40, −0.60

I₀_{_}ₗᵢₘ_{_}_{b}=0.30, −0.70

I₀_{_}ₗᵢₘ_{_}_{c}=0.30, −0.70

The negative solutions are discarded, and the smallest solution from all three phases is chosen as the maximum limit on I₀. Therefore, one gets:

\vec{I}₀=0.3∠−90°

, which results in the following three-phase AC quantities:

\vec{V}ₐ=1.00∠0° Iₐ=0.1∠90°

\vec{V}_{b}=0.58∠−150° \vec{I}_{b}=1.0∠−30°

\vec{V}_{c}=0.58∠150° I_{c}=1.0∠−150°

The necessary DC currents are then computed as:

$$[ \begin{matrix}{I}_{DC , a} \\ {I}_{DC , b} \\ {I}_{DC , c}\end{matrix} ] = - \frac{2}{{V}_{DC}} ( Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ] ) = [ \begin{matrix}0 \\ 0.58 \\ - 0.58\end{matrix} ]$$

These new DC currents are approximately 23% lower than those necessary if no zero-sequence current is used.

| | Zero-sequence | |
|---|---|---|
| DC current method | voltage method | Combined method |
| \vec{V}ₐ = 1.00∠0° | \vec{V}ₐ = 1.00∠0° | \vec{V}ₐ = 1.00∠0° |
| \vec{V}_{b} = 0.58∠−150° | \vec{V}_{b} = 0.58∠−150° | \vec{V}_{b} = 0.58∠−150° |
| \vec{V}_{c} = 0.58∠150° | \vec{V}_{c} = 0.58∠150° | \vec{V}_{c} = 0.58∠150° |
| \vec{I}ₐ = 0.40∠90° | \vec{I}ₐ = 0.90∠−90° | \vec{I}ₐ = 0.1∠90° |
| \vec{I}_{b} = 0.89∠−13.0° | \vec{I}_{b} = 1.73∠−60° | \vec{I}_{b} = 1.0∠−30° |
| \vec{I}_{c} = 0.89∠−167.7° | \vec{I}_{c} = 1.73∠−120° | \vec{I}_{c} = 1.0∠−150° |
| \vec{I}₀ = 0∠0° | \vec{I}₀ = 1.30∠−90° | \vec{I}₀ = 0.30∠−90° |
| $[ \begin{matrix}{I}_{DC , a} \\ {I}_{DC , b} \\ {I}_{DC , c}\end{matrix} ] = [ \begin{matrix}0 \\ - 0.75 \\ 0.75\end{matrix} ]$ | $[ \begin{matrix}{I}_{DC , a} \\ {I}_{DC , b} \\ {I}_{DC , c}\end{matrix} ] = [ \begin{matrix}0 \\ 0 \\ 0\end{matrix} ]$ | $[ \begin{matrix}{I}_{DC , a} \\ {I}_{DC , b} \\ {I}_{DC , c}\end{matrix} ] = [ \begin{matrix}0 \\ 0.58 \\ - 0.58\end{matrix} ]$ |

It is noted that it would not be possible to apply the zero-sequence voltage method for this example because the required zero-sequence voltage would be in phase with the voltage in phase a, which is already at it's acceptable limit.

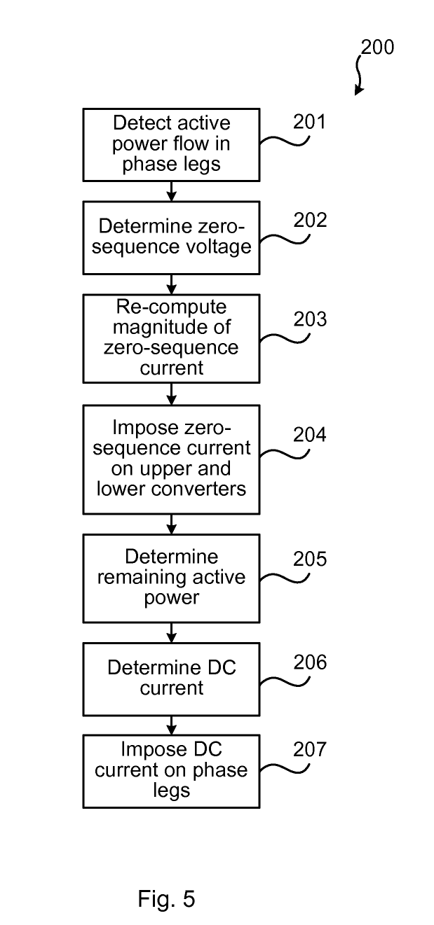

FIG. 5 illustrates in a flow chart embodiments of a method 200 based on the above description. The method 200 can be implemented and performed in a device 20 for controlling unbalanced active power flow in a three-phase modular multilevel converter 30. The converter 30 comprises an upper converter 4 comprising three phase legs A_{U}, B_{U}, C_{U} arranged in a wye-connection and a lower converter 5 comprising three phase legs A_{L}, B_{L}, C_{L} connected in a wye-connection. The upper converter 4 and the lower converter 5 are interconnected in a double-wye connection. The neutral paths of the upper converter 4 and the lower converter 5 are connected to ground.

The method 200 comprises detecting 201 an active power flow in the phase legs A_{U}, B_{U}, C_{U}; A_{L}, B_{L}, C_{L}. This step may be performed in the same manner as described for step 101 of method 100, and will not be repeated here.

Next, a zero-sequence current is determined 202. The determination provides a magnitude I₀ and phase α₀ of the zero-sequence current. For this step, refer to equations (19), (20), (21), (22), (23) and (24) and related description.

Next, the magnitude I₀ of the zero-sequence current is recomputed 203 while keeping the phase α₀ of the zero-sequence current fixed. The magnitude being recomputed with the requirement that the resulting currents in the phase legs A_{U}, B_{U}, C_{U}; A_{L}, B_{L}, C_{L} is smaller than or equal to a maximum allowed leg current I_{ac max}. The recomputed magnitude and the phase a₀ give a re-computed zero-sequence current. For this step, refer to equations (35), (36), (37), (38), (39), (40) and (41) and related description.

Next, the recomputed zero-sequence current is imposed 204 on the phase legs of the upper and lower converters 4, 5, thereby reducing the active power flow.

Next, any remaining active power is determined 205 based on the re-computed magnitude of the zero-sequence current. For this step, refer to equation (42) and related description.

Next, a DC current is determined 206 giving a product with a DC voltage of the upper and lower converters 4, 5 that will counteract the remaining active power. For this step, refer to equations (11), (12) and (43), (44) and respective related descriptions.

Finally, the DC current is imposed 207 on the phase legs A_{U}, B_{U}, C_{U}; A_{L}, B_{L}, C_{L}, thereby eliminating the remaining active power flow.

In another variation of the above method 200, a battery storage device (not illustrated) is connected to the neutral paths of the upper converter 4 and the lower converter 5.

In a variation of the above method 200, the neutral paths of the upper converter 4 and the lower converter 5 are connected to ground through an impedance. The impedance may be a fixed impedance or a variable impedance.

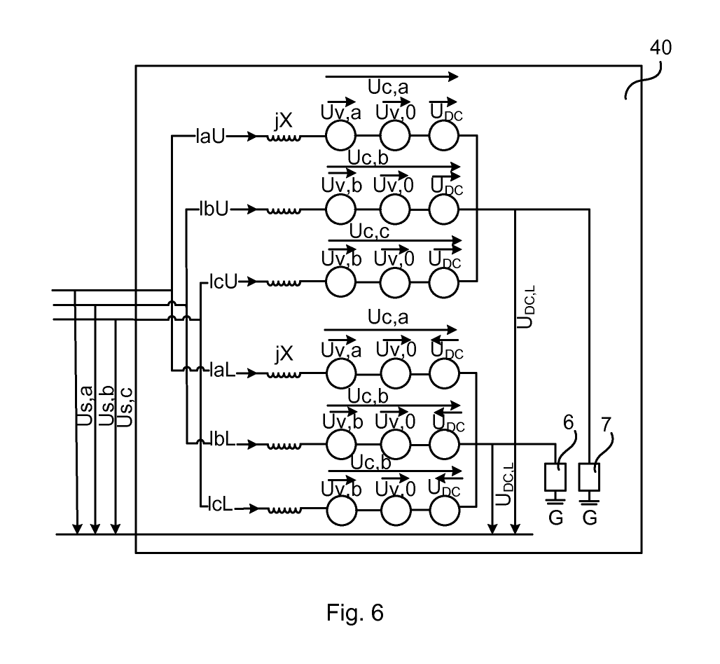

The above description of the use of zero-sequence current method and DC current method in combination, illustrates an “ideal” neutral current path which has no impedance. FIG. 6 illustrates a more real situation, comprising the upper and lower converters 4, 5 being grounded through a respective impedance 6, 7 instead. The impedances 6, 7 represents the neutral paths having a certain impedance, e.g. due to the fact that a grounding transformers have some non-zero impedance. Thus, the embodiment of including a fixed impedance is illustrated in FIG. 6 and the above description of using a zero-sequence current method and DC current method in combination is applicable in all parts also to FIG. 6.

With reference to FIGS. 4 and 6, the invention also encompasses the control device 21 configured to control unbalanced active power flow in a three-phase modular multilevel converter 30, 40. The modular multilevel converter 30, 40 comprises a first converter 4 comprising three phase legs A_{U}, B_{U}, C_{U} arranged in a wye-connection and a second converter 5 comprising three phase legs A_{L}, B_{L}, C_{L} connected in a wye-connection. The first converter 4 and the second converter 5 are interconnected in a double-wye connection, and the first converter 4 and the second converter 5 neutral paths are grounded. The device 21 comprises a processor 22 and memory 33, the memory 33 containing instructions executable by the processor 22, whereby the device 21 is operative to perform the method 200 as described. In particular, the device 21 is operative to: detect an active power flow in the phase legs A_{U}, B_{U}, C_{U}; A_{L}, B_{L}, C_{L}; determine a zero-sequence current, the determination providing magnitude I₀ and phase α₀ of the zero-sequence current; re-compute the magnitude I₀ of the zero-sequence current while keeping the phase α₀ of the zero-sequence current fixed, the magnitude being re-computed with the requirement that the resulting currents in the phase legs A_{U}, B_{U}, C_{U}; A_{L}, B_{L}, C_{L} is smaller than or equal to a maximum allowed leg current I_{ac max}, the re-computed magnitude and the phase α₀ giving a re-computed zero-sequence current; impose the re-computed zero-sequence current on the first and second converters, thereby reducing the active power flow; determine remaining active power based on the re-computed magnitude of the zero-sequence current; determine, a DC current giving a product with a DC voltage of the first and second converters 4, 5 that will counteract the remaining active power; and impose the DC current on the phase legs A_{U}, B_{U}, C_{U}; A_{L}, B_{L}, C_{L}, thereby eliminating the remaining active power flow.

With reference still to FIGS. 4 and 6, the invention also encompasses computer program 34 for controlling unbalanced active power flow in a three-phase modular multilevel converter 30, 40. The computer program 34 comprises computer program code, or instructions, which when run on the control device 21, and in particular the processor 22 thereof, causes the control device 21 to perform the methods as described.

A computer program product 33 is also provided comprising the computer program 34 and computer readable means on which the computer program 34 is stored. The computer program product 33 may be any combination of read and write memory (RAM) or read only memory (ROM). The computer program product 33 may also comprise persistent storage, which for example can be any single one or combination of magnetic memory, optical memory or solid state memory.

It is possible to describe both the STATCOM with decoupled DC buses (FIG. 2) and the STATCOM with a zero-sequence current path (FIG. 4) by a general method with a zero-sequence impedance (FIG. 6). The STATCOM with decoupled DC buses corresponds to an infinite zero-sequence impedance in the neutral, while the one with a zero-sequence current path corresponds to no impedance in the neutral. It is also possible to describe the general case of a non-zero but finite impedance which would allow the use of both a zero-sequence voltage and a zero-sequence current in combination with the DC current method.

The relationship between zero-sequence voltage and zero-sequence current then becomes:

\vec{V}₀=3\vec{Z}₀\vec{I}₀ and \vec{Z}₀=Z₀φζ

where the factor 3 comes from the fact that the current in the neutral is equal to three times the zero sequence current. Therefore one gets:

$${\vec{V}}_{U} = [ \begin{matrix}1 \\ 1 \\ 1\end{matrix} ] 3 {\vec{Z}}_{0} {\vec{I}}_{0} {e}^{j ωt} + [ \begin{matrix}1 \\ {α}^{2} \\ α\end{matrix} ] {\vec{V}}_{1} {e}^{j ωt} + [ \begin{matrix}1 \\ α \\ {α}^{2}\end{matrix} ] {\vec{V}}_{2} {e}^{j ω t} + \frac{{V}_{DC}}{2} [ \begin{matrix}1 \\ 1 \\ 1\end{matrix} ]$$

$${\vec{V}}_{L} = [ \begin{matrix}1 \\ 1 \\ 1\end{matrix} ] 3 {\vec{Z}}_{0} {\vec{I}}_{0} {e}^{j ω t} + [ \begin{matrix}1 \\ {α}^{2} \\ α\end{matrix} ] {\vec{V}}_{1} {e}^{j ωt} + [ \begin{matrix}1 \\ α \\ {α}^{2}\end{matrix} ] {\vec{V}}_{2} {e}^{j ω t} - \frac{{V}_{DC}}{2} [ \begin{matrix}1 \\ 1 \\ 1\end{matrix} ]$$

Upper and lower leg currents (positive sequence and negative sequence only):

$${\vec{I}}_{U} = [ \begin{matrix}1 \\ 1 \\ 1\end{matrix} ] {\vec{I}}_{0} {e}^{j ω t} + [ \begin{matrix}1 \\ {α}^{2} \\ α\end{matrix} ] {\vec{I}}_{1} {e}^{j ω t} + [ \begin{matrix}1 \\ α \\ {α}^{2}\end{matrix} ] {\vec{I}}_{2} {e}^{j ω t}$$

$${\vec{I}}_{L} = [ \begin{matrix}1 \\ 1 \\ 1\end{matrix} ] {\vec{I}}_{0} {e}^{j ω t} + [ \begin{matrix}1 \\ {α}^{2} \\ α\end{matrix} ] {\vec{I}}_{1} {e}^{j ω t} + [ \begin{matrix}1 \\ α \\ {α}^{2}\end{matrix} ] {\vec{I}}_{2} {e}^{j ω t}$$

The active power in the upper converter is then:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ 3 {\vec{Z}}_{0} {\vec{I}}_{0} {\vec{I}}_{1}^{*} [ \begin{matrix}1 \\ α \\ {α}^{2}\end{matrix} ] ] + Re [ 3 {\vec{Z}}_{0} {\vec{I}}_{0} {\vec{I}}_{2}^{*} [ \begin{matrix}1 \\ {α}^{2} \\ {α}^{ }\end{matrix} ] ] + Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ]$$

By setting the following condition:

$$Re [ 3 {\vec{Z}}_{0} {\vec{I}}_{0} {\vec{I}}_{1}^{*} [ \begin{matrix}1 \\ α \\ {α}^{2}\end{matrix} ] ] + Re [ 3 {\vec{Z}}_{0} {\vec{I}}_{0} {\vec{I}}_{2}^{*} [ \begin{matrix}1 \\ {α}^{2} \\ α\end{matrix} ] ] + Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ] = - Re [ {\vec{V}}_{1} {\vec{I}}_{2}^{*} [ \begin{matrix}1 \\ α \\ {α}^{2}\end{matrix} ] ] - Re [ {\vec{V}}_{2} {\vec{I}}_{1}^{*} [ \begin{matrix}1 \\ {α}^{2} \\ α\end{matrix} ] ]$$

it is then possible to solve for \vec{I}₀. We then get:

$${I}_{0} = \frac{( {V}_{1} {I}_{2} + {V}_{2} {I}_{1} ) sin ( {ϕ}_{1} - {ϕ}_{2} )}{\begin{matrix}3 {Z}_{0} {I}_{1} sin ( ζ + {ϕ}_{0} - {ϕ}_{1} ) - 3 {Z}_{0} {I}_{2} sin ( ζ + {ϕ}_{0} - {ϕ}_{2} ) + {V}_{1} cos ( {ϕ}_{1} - {ϕ}_{0} ) + \\ {V}_{2} cos ( {ϕ}_{2} - {ϕ}_{0} )\end{matrix}}$$

$${ϕ}_{0} = - arctan ( \frac{\begin{matrix}( 3 {Z}_{0} {I}_{1} sin ( ζ ) + {V}_{1} ) + 3 {Z}_{0} {I}_{2} cos ( ζ ) sin ( - 3 {ϕ}_{1} + 3 {ϕ}_{2} ) - \\ ( 3 {Z}_{0} {I}_{2} sin ( ζ ) - {V}_{2} ) cos ( - 3 {ϕ}_{1} + 3 {ϕ}_{2} )\end{matrix}}{\begin{matrix}( 3 {Z}_{0} {I}_{1} cos ( ζ ) ) - 3 {Z}_{0} {I}_{2} cos ( ζ ) cos ( - 3 {ϕ}_{1} + 3 {ϕ}_{2} ) - \\ ( 3 {Z}_{0} {I}_{2} sin ( ζ ) - {V}_{2} ) sin ( - 3 {ϕ}_{1} + 3 {ϕ}_{2} )\end{matrix}} ) + 2 {ϕ}_{1} - {ϕ}_{2}$$

If instead an expression for V₀ is preferred, one can simply make use of the fact that:

V₀∠φ_{v,0}=3Z₀∠ζ·I₀∠φ_{i,0}=3Z₀I₀∠(φ_{i,0}+ζ)

For a given neutral path impedance, both the leg voltage limit and the leg current limit must be checked when assessing how much of the unbalance can be compensated for by zero-sequence currents and zero-sequence voltages. The remaining unbalance is then compensated using the DC current method I₀ (described earlier, compare equations (11), (12) and related description.

It is important to note that since the impedance is fixed, the ratio between zero-sequence current and zero-sequence voltage is also fixed. Of course, care must be taken to choose the value of this zero sequence impedance in coordination with the voltage and current ratings of the STATCOM.

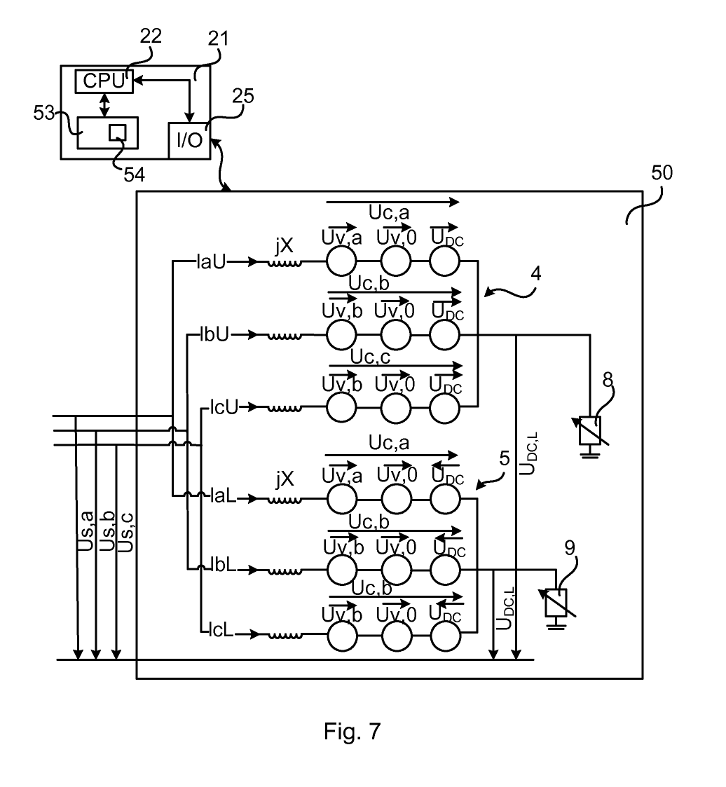

With reference now to FIG. 7, yet another embodiment of the invention will be described next. FIG. 7 illustrates a modular multilevel converter which is identical to the one described in relation to FIG. 2, with the exception of the upper and lower converter 4, 5 neutral paths having a variable impedance 8, 9, that is, the neutral paths of the upper converter 4 is grounded through a variable impedance 8, and the lower converter 5 is grounded through a variable impedance 9. The variable impedances 8, 9 may be implemented e.g. by using a converter valve. The description provided in relation to FIG. 2 is in all other ways applicable also to FIG. 7, and will not be repeated.

Again, the control device 21 described in relation to FIG. 2 may be configured to control the converter 50 in accordance with the methods to be described below, which configuration can be adapted by using same or different memory 23, 53 however comprising different set of instructions executable by the processor 23 compared to the instructions of the previous embodiments. The description of the control device 21 given in relation to FIG. 2 is applicable in all other ways also for the embodiment of FIG. 7.

### Use of Zero-Sequence Voltage Method, Zero-Sequence Current Method and DC Current Method Concurrently:

FIG. 7 illustrates the case wherein the neutral paths of the upper and lower converters 4, 5 are grounded through variable impedances 8, 9. This enables the concurrent and independent use of the zero-sequence voltage method, the zero-sequence current method and the DC current method in the controlling of the active flow.

It is noted that this embodiment is suited also for controlling unbalanced active power flow in a single wye MMC STATCOM. Such single wye MMC STATCOM is not illustrated in the figures, but simply comprises only one of the upper and lower converters 4, 5.

As described so far, the zero-sequence current method I₀ can be used in certain situations where the zero-sequence voltage method V₀ is inefficient and vice-versa. It is therefore interesting to have a STATCOM which can switch between both methods, but also which can use any ratio of the two methods in order to optimize leg voltages and currents.

If the neutral path impedance uses a variable impedance, e.g. an additional valve leg in addition to the chosen grounding method, its equivalent impedance can be chosen to take any value between zero and infinity both in the capacitive and the inductive range (also possibly the positive and negative resistive range if energy storage is included). In order to choose the optimal impedance value, the following method can be applied. For a general unbalance case, the active power unbalance terms are:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ]$$

The zero-sequence voltage is chosen to be the largest allowed V₀ that will ensure that all leg voltages are below V_{ac max}. The expression for total unbalance then becomes:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ]$$

Then, the zero sequence current is chosen to be the largest allowed I₀ that will ensure that all leg currents are below I_{ac max}. The expression for total unbalance then becomes:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] + [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ]$$

The required zero-sequence impedance is then chosen as:

$${Z}_{0} ∠ζ = \frac{1}{3} \frac{{V}_{0} {∠ϕ}_{v , 0}}{{I}_{0} {∠ϕ}_{i , 0}}$$

Finally, any remaining unbalance is corrected using DC currents in accordance with DC current method I_{DC}.

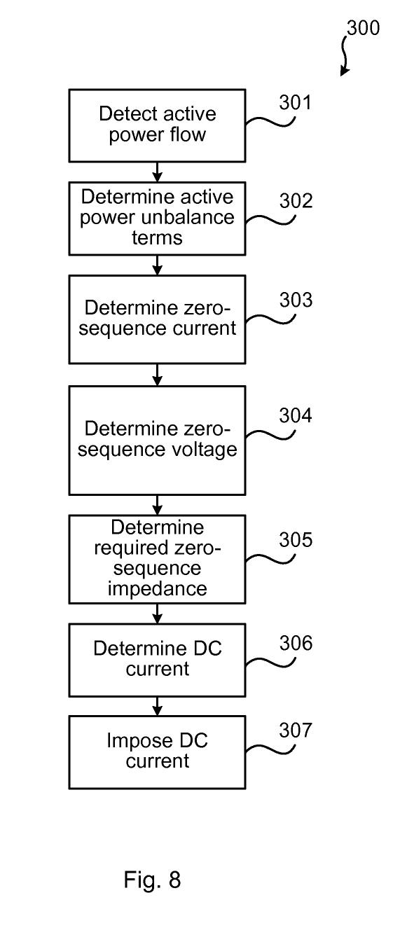

FIG. 8 illustrates a flow chart over steps of a method 300 performed in a device 21 for controlling unbalanced active power flow in a three-phase modular multilevel converter 50. The converter 50 comprises a first converter 4 comprising three phase legs A_{U}, B_{U}, C_{U} arranged in a wye-connection. The first converter 4 neutral path is connected to ground through a variable impedance 8.

The method 300 comprise detecting 301 an active power flow in the phase legs (A_{U}, B_{U}, C_{U}). This can be done in a corresponding way as has been described for the above methods.

Next, active power \vec{P} unbalance terms are determined 302 by

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] , ,$$

wherein \vec{V}₁, \vec{V}₂ are power network 1 positive and negative sequence voltages, respectively, and \vec{I}₁, \vec{I}₂ are converter 50 positive sequence currents.

Next, a zero-sequence voltage is determined 303 to be the largest allowed voltage that ensures that all phase leg A_{U}, B_{U}, C_{U} voltages are below a maximum voltage V_{ac max}, the total unbalance then being determined by:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ]$$

Next, a zero-sequence current I₀ is determined 304 to be the largest allowed current that ensures that all phase leg currents are below a maximum current I_{ac max}, whereby total unbalance is given by:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] + [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ]$$

Next, a required zero-sequence impedance is determined 305 to be

$${Z}_{0} ∠ζ = \frac{1}{3} \frac{{V}_{0} {∠ϕ}_{v , 0}}{{I}_{0} {∠ϕ}_{i , 0}}$$

The variable impedance 8 is set accordingly.

Next a DC current is determined 306 giving a product with a DC voltage of the first converter that will counteract any remaining active power.

Finally, the determined DC current is imposed 307 on the phase legs A_{U}, B_{U}, C_{U}, thereby eliminating any remaining active power flow.

In an embodiment of the method 300 as above, the three-phase modular multilevel converter 50 comprises a second converter 5 comprising three phase legs A_{L}, B_{L}, C_{L} connected in a wye-connection. The first converter 4 and the second converter 5 are interconnected in a double-wye connection. The upper converter 4 and the lower converter 5 neutral paths are connected to ground through a respective variable impedance 8, 9. The variable impedance enables to use concurrently and independently the zero-sequence voltage method and the zero-sequence current method and is taken advantage of in the embodiments 200 and 300 of the controls methods. In the last embodiment, method 300, the method can be applied also to a single-wye MMC STATCOM.

With reference to FIG. 7, the invention encompasses a device 21 for controlling unbalanced active power flow in a three-phase modular multilevel converter 50. The modular multilevel converter 50 comprises a first converter 4 comprising three phase legs A_{U}, B_{U}, C_{U} arranged in a wye-connection. The first converter 4 neutral path is connected to ground through a variable impedance 8. The device 21 comprises a processor 22 and memory 53, the memory 53 containing instructions executable by the processor 22, whereby the device 21 is operative to:
detect an active power flow in the phase legs A_{U}, B_{U}, C_{U};
determine active power \vec{P} unbalance terms by

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] , ,$$

wherein \vec{V}₁, \vec{V}₂ are power network 1 positive and negative sequence voltages, respectively, and \vec{I}₁, \vec{I}₂ are modular multilevel converter 50 positive sequence currents;
determine a zero-sequence voltage to be the largest allowed voltage that ensures that all phase leg A_{U}, B_{U}, C_{U} voltages are below a maximum voltage V_{ac max}, the total unbalance then being determined by:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ]$$

determine a zero-sequence current I₀ to be the largest allowed current that ensures that all phase leg currents are below a maximum current I_{ac max}, whereby total unbalance is given by:

$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] + [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ]$$

determine and setting a required zero-sequence impedance to be

$${Z}_{0} ∠ζ = \frac{1}{3} \frac{{V}_{0} {∠ϕ}_{v , 0}}{{I}_{0} {∠ϕ}_{i , 0}}$$

determine a DC current giving a product with a DC voltage of the first converter that will counteract any remaining active power;
impose the DC current on the phase legs (A_{U}, B_{U}, C_{U}), thereby eliminating any remaining active power flow.

With reference still to FIG. 7, the invention also encompasses computer program 54 for controlling unbalanced active power flow in a three-phase modular multilevel converter 50. The computer program 54 comprises computer program code, or instructions, which when run on the control device 21, and in particular the processor 22 thereof, causes the control device 21 to perform the methods as described, in particular the method 300 described above.

A computer program product 53 is also provided comprising the computer program 54 and computer readable means on which the computer program 54 is stored. The computer program product 53 may be any combination of read and write memory (RAM) or read only memory (ROM). The computer program product 53 may also comprise persistent storage, which for example can be any single one or combination of magnetic memory, optical memory or solid state memory.

1-13. (canceled)

14. A method performed in a device for controlling unbalanced active power flow in a three-phase modular multilevel converter, the modular multilevel converter comprising a first converter comprising three phase legs arranged in a wye-connection and a second converter comprising three phase legs connected in a wye-connection, the first converter and the second converter being interconnected in a double-wye connection, the first converter and the second converter neutral paths being independently floating, wherein the method comprises:
detecting an active power flow in the phase legs;
determining a zero-sequence voltage, the determination providing magnitude and phase of the zero-sequence voltage;
re-computing the magnitude of the zero-sequence voltage while keeping the phase of the zero-sequence voltage fixed, the magnitude being re-computed with the requirement that the resulting voltage over the phase legs is smaller than or equal to a maximum allowed leg voltage, the re-computed magnitude and the phase giving a re-computed zero-sequence voltage;
imposing the re-computed zero-sequence voltage on the neutral point of the first and second converters, thereby reducing the active power flow;
determining remaining active power based on the re-computed magnitude of the zero-sequence voltage;
determining a DC current giving a product with a DC voltage of the first and second converters that will counteract the remaining active power; and
imposing the DC current on the phase legs, thereby eliminating the active power flow.

15. The method as claimed in claim 14, wherein a battery is connected between the neutral path of the first converter and the neutral path of the second converter.

16. The method as claimed in claim 14, wherein the determining of the zero-sequence voltage comprises using the equations:
$$\begin{matrix} {\vec{V}}_{U} = [ \begin{matrix}1 \\ 1 \\ 1\end{matrix} ] {\vec{V}}_{0} {e}^{jω t} + [ \begin{matrix}1 \\ {α}^{2} \\ α\end{matrix} ] {\vec{V}}_{1} {e}^{jω t} + [ \begin{matrix}1 \\ α \\ {α}^{2}\end{matrix} ] {\vec{V}}_{2} {e}^{jω t} + \frac{{V}_{DC}}{2} [ \begin{matrix}1 \\ 1 \\ 1\end{matrix} ] & ( 13 ) \\ {\vec{V}}_{L} = [ \begin{matrix}1 \\ 1 \\ 1\end{matrix} ] {\vec{V}}_{0} {e}^{jω t} + [ \begin{matrix}1 \\ {α}^{2} \\ α\end{matrix} ] {\vec{V}}_{1} {e}^{jω t} + [ \begin{matrix}1 \\ α \\ {α}^{2}\end{matrix} ] {\vec{V}}_{2} {e}^{jω t} - \frac{{V}_{DC}}{2} [ \begin{matrix}1 \\ 1 \\ 1\end{matrix} ] & ( 14 ) \\ \vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] + Re [ {\vec{V}}_{2} {\vec{I}}_{1}^{*} [ \begin{matrix}1 \\ {α}^{2} \\ α\end{matrix} ] ] & ( 15 ) \\ Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] = - Re [ {\vec{V}}_{1} {\vec{I}}_{2}^{*} [ \begin{matrix}1 \\ α \\ {α}^{2}\end{matrix} ] ] - Re [ {\vec{V}}_{2} {\vec{I}}_{1}^{*} [ \begin{matrix}1 \\ {α}^{2} \\ α\end{matrix} ] ] & ( 16 ) \\ {V}_{0} = \frac{( {V}_{1} {I}_{2} + {V}_{2} {I}_{1} ) sin ( {ϕ}_{1} - {ϕ}_{2} )}{{I}_{1} sin ( {ϕ}_{0} - {ϕ}_{1} ) - {I}_{2} sin ( {ϕ}_{0} - {ϕ}_{2} )} & ( 17 ) \\ {ϕ}_{0} = - arctan ( \frac{{I}_{2} sin ( - 3 {ϕ}_{1} + 3 {ϕ}_{2} )}{{I}_{1} - {I}_{2} cos ( - 3 {ϕ}_{1} + 3 {ϕ}_{2} )} ) + 2 {ϕ}_{1} - {ϕ}_{2} . & ( 18 )\end{matrix}$$

17. The method as claimed in claim 14, wherein the re-computing of the magnitude of the zero-sequence voltage comprises using the equations:
$$\begin{matrix}{\vec{V}}_{U} [ \begin{matrix}1 \\ 1 \\ 1\end{matrix} ] {\vec{V}}_{0} {e}^{jω t} + [ \begin{matrix}1 \\ {α}^{2} \\ α\end{matrix} ] {\vec{V}}_{1} {e}^{jω t} + [ \begin{matrix}1 \\ α \\ {α}^{2}\end{matrix} ] {\vec{V}}_{2} {e}^{jω t} & ( 25 ) \\ {\vec{V}}_{a} = 1 \cdot {V}_{0} {e}^{{jϕ}_{0}} + 1 \cdot {V}_{1} {e}^{{jϕ}_{1}} + 1 \cdot {V}_{2} {e}^{{jϕ}_{2}} & ( 26 ) \\ {\vec{V}}_{b} = 1 \cdot {V}_{0} {e}^{{jϕ}_{0}} + {α}^{2} \cdot {V}_{1} {e}^{{jϕ}_{1}} + α \cdot {V}_{2} {e}^{{jϕ}_{2}} & ( 27 ) \\ {\vec{V}}_{c} = 1 \cdot {V}_{0} {e}^{{jϕ}_{0}} + α \cdot {V}_{1} {e}^{{jϕ}_{1}} + {α}^{2} \cdot {V}_{2} {e}^{{jϕ}_{2}} & ( 28 ) \\ \vert {\vec{V}}_{a} \vert = \vert {V}_{0} {e}^{{jϕ}_{0}} + {V}_{1} {e}^{{jϕ}_{1}} + {V}_{2} {e}^{{jϕ}_{2}} \vert \leq {V}_{ac max} & ( 29 ) \\ {aV}_{0} \leq - ( {V}_{1} cos ( {ϕ}_{0} - {ϕ}_{1} ) + {V}_{2} cos ( {ϕ}_{0} - {ϕ}_{2} ) ) \pm & ( 30 ) \\ \sqrt{\begin{matrix}{( {V}_{1} cos ( {ϕ}_{0} - {ϕ}_{1} ) + {V}_{2} cos ( {ϕ}_{0} - {ϕ}_{2} ) )}^{2} - \\ ( {V}_{1}^{2} + {V}_{2}^{2} + 2 {V}_{1} {V}_{2} cos ( {ϕ}_{1} - {ϕ}_{2} ) - {V}_{ac max}^{2} )\end{matrix}} & ( 31 )\end{matrix}$$

18. A control device for controlling unbalanced active power flow in a three-phase modular multilevel converter, the modular multilevel converter comprising a first converter comprising three phase legs arranged in a wye-connection and a second converter comprising three phase legs connected in a wye-connection, the first converter and the second converter being interconnected in a double-wye connection, the first converter and the second converter neutral paths being independently floating, the control device comprising a processor and memory, the memory containing instructions executable by the processor, whereby the control device is operative to:
detect an active power flow in the phase legs,
determine a zero-sequence voltage, the determination providing magnitude and phase of the zero-sequence voltage,
re-compute the magnitude of the zero-sequence voltage while keeping the phase of the zero-sequence voltage fixed, the magnitude being re-computed with the requirement that the resulting voltage over the phase legs is smaller than or equal to a maximum allowed leg voltage, the re-computed magnitude and the phase giving a re-computed zero-sequence voltage,
impose the re-computed zero-sequence voltage on the neutral point of the first and second converters, thereby reducing the active power flow,
determine remaining active power based on the re-computed magnitude of the zero-sequence voltage,
determine, a DC current giving a product with a DC voltage of the first and second converters that will counteract the remaining active power, and
impose the DC current on the phase legs, thereby eliminating the active power flow.

19. A method performed in a device for controlling unbalanced active power flow in a three-phase modular multilevel converter, the modular multilevel converter comprising a first converter comprising three phase legs arranged in a wye-connection and a second converter comprising three phase legs connected in a wye-connection, the first converter and the second converter being interconnected in a double-wye connection, the first converter and the second converter neutral paths being connected to ground, wherein the method comprises:
detecting an active power flow in the phase legs;
determining a zero-sequence current, the determination providing magnitude and phase of the zero-sequence current;
re-computing the magnitude of the zero-sequence current while keeping the phase of the zero-sequence current fixed, the magnitude being re-computed with the requirement that the resulting currents in the phase legs is smaller than or equal to a maximum allowed leg current, the re-computed magnitude and the phase giving a re-computed zero-sequence current;
imposing the re-computed zero-sequence current on the first and second converters, thereby reducing the active power flow;
determining remaining active power based on the re-computed magnitude of the zero-sequence current;
determining, a DC current giving a product with a DC voltage of the first and second converters that will counteract the remaining active power; and
imposing the DC current on the phase legs, thereby eliminating the remaining active power flow.

20. The method as claimed in claim 19, wherein the first converter and the second converter are connected to ground through an impedance.

21. The method as claimed in claim 20, wherein the impedance comprises a fixed impedance.

22. The method as claimed in claim 20, wherein the impedance comprises a variable impedance.

23. A device for controlling unbalanced active power flow in a three-phase modular multilevel converter, the modular multilevel converter comprising a first converter comprising three phase legs arranged in a wye-connection and a second converter comprising three phase legs connected in a wye-connection, the first converter and the second converter being interconnected in a double-wye connection, the first converter and the second converter neutral paths being grounded, wherein the device comprises a processor and memory, the memory containing instructions executable by the processor, whereby the device is operative to:
detect an active power flow in the phase legs;
determine a zero-sequence current, the determination providing magnitude and phase of the zero-sequence current;
re-compute the magnitude of the zero-sequence current while keeping the phase of the zero-sequence current fixed, the magnitude being re-computed with the requirement that the resulting currents in the phase legs is smaller than or equal to a maximum allowed leg current, the re-computed magnitude and the phase giving a re-computed zero-sequence current;
impose the re-computed zero-sequence current on the first and second converters, thereby reducing the active power flow;
determine remaining active power based on the re-computed magnitude of the zero-sequence current;
determine, a DC current giving a product with a DC voltage of the first and second converters that will counteract the remaining active power; and
impose the DC current on the phase legs, thereby eliminating the remaining active power flow.

24. A method performed in a device for controlling unbalanced active power flow in a three-phase modular multilevel converter, the converter comprising an first converter comprising three phase legs arranged in a wye-connection, the first converter neutral path being connected to ground through a variable impedance, wherein the method comprises:
detecting an active power flow in the phase legs;
determining active power P unbalance terms by
$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] ,$$
wherein \vec{V}₁, \vec{V}₂ are power network 1 positive and negative sequence voltages, respectively, and \vec{I}₁, \vec{I}₂ are converter positive sequence currents;
determining a zero-sequence voltage to be the largest allowed voltage that ensures that all phase leg voltages are below a maximum voltage V_{ac max}, the total unbalance then being determined by:
$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] ;$$
determining a zero-sequence current I₀ to be the largest allowed current that ensures that all phase leg currents are below a maximum current I_{ac max}, whereby total unbalance is given by:
$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] + Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ] ;$$
determining and setting a required zero-sequence impedance to be
$${Z}_{0} ∠ζ = \frac{1}{3} \frac{ {V}_{0} {∠ϕ}_{v , 0}}{ {I}_{0} {∠ϕ}_{i , 0}} ,$$
whereby active power unbalance is compensated for by the determined zero-sequence voltage and zero-sequence current;
determining, a DC current giving a product with a DC voltage of the first converter that will counteract any remaining active power; and
imposing the DC current on the phase legs, thereby eliminating any remaining active power flow.

25. The method as claimed in claim 24, wherein the three-phase modular multilevel converter comprises a second converter comprising three phase legs connected in a wye-connection, the first converter and the second converter being interconnected in a double-wye connection, the upper converter and the lower converter neutral paths being connected to ground through a respective variable impedance.

26. A device for controlling unbalanced active power flow in a three-phase modular multilevel converter, the converter comprising an first converter comprising three phase legs arranged in a wye-connection, the first converter neutral path being connected to ground through a variable impedance, wherein the device comprises a processor and memory, the memory containing instructions executable by the processor, whereby the device is operative to:
detect an active power flow in the phase legs;
determine active power \vec{P} unbalance terms by
$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] ,$$
wherein \vec{V}₁, \vec{V}₂ are power network 1 positive and negative sequence voltages, respectively, and \vec{I}₁, \vec{I}₂ are modular multilevel converter positive sequence currents;
determine a zero-sequence voltage to be the largest allowed voltage that ensures that all phase leg voltages are below a maximum voltage V_{ac max}, the total unbalance then being determined by:
$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] ;$$
determine a zero-sequence current I₀ to be the largest allowed current that ensures that all phase leg currents are below a maximum current L_{ac max}, whereby total unbalance is given by:
$$\vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{2} {\vec{I}}_{1}^{*} [ \begin{matrix}1 \\ {α}^{2} \\ α\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] + Re [ {\vec{V}}_{1} {\vec{I}}_{0}^{*} [ \begin{matrix}1 \\ {α}^{2} \\ α\end{matrix} ] ] + Re [ {\vec{V}}_{2} {\vec{I}}_{0}^{*} [ \begin{matrix}1 \\ α \\ {α}^{2}\end{matrix} ] ] ;$$
determine and setting a required zero-sequence impedance to be
$${Z}_{0} ∠ζ = \frac{1}{3} \frac{ {V}_{0} {∠ϕ}_{v , 0}}{ {I}_{0} {∠ϕ}_{i , 0}} ;$$
determine a DC current giving a product with a DC voltage of the first converter that will counteract any remaining active power; and
impose the DC current on the phase legs, thereby eliminating any remaining active power flow.

27. The method as claimed in claim 15, wherein the determining of the zero-sequence voltage comprises using the equations:
$$\begin{matrix} {\vec{V}}_{U} = [ \begin{matrix}1 \\ 1 \\ 1\end{matrix} ] {\vec{V}}_{0} {e}^{jω t} + [ \begin{matrix}1 \\ {α}^{2} \\ α\end{matrix} ] {\vec{V}}_{1} {e}^{jω t} + [ \begin{matrix}1 \\ α \\ {α}^{2}\end{matrix} ] {\vec{V}}_{2} {e}^{jω t} + \frac{{V}_{DC}}{2} [ \begin{matrix}1 \\ 1 \\ 1\end{matrix} ] & ( 13 ) \\ {\vec{V}}_{L} = [ \begin{matrix}1 \\ 1 \\ 1\end{matrix} ] {\vec{V}}_{0} {e}^{jω t} + [ \begin{matrix}1 \\ {α}^{2} \\ α\end{matrix} ] {\vec{V}}_{1} {e}^{jω t} + [ \begin{matrix}1 \\ α \\ {α}^{2}\end{matrix} ] {\vec{V}}_{2} {e}^{jω t} - \frac{{V}_{DC}}{2} [ \begin{matrix}1 \\ 1 \\ 1\end{matrix} ] & ( 14 ) \\ \vec{P} = Re [ {\vec{V}}_{1} {\vec{I}}_{2}^{*} [ \begin{matrix}1 \\ α \\ {α}^{2}\end{matrix} ] ] + Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] + Re [ {\vec{V}}_{2} {\vec{I}}_{1}^{*} [ \begin{matrix}1 \\ {α}^{2} \\ α\end{matrix} ] ] & ( 15 ) \\ Re [ {\vec{V}}_{0} {\vec{I}}_{1}^{*} [ \begin{matrix}1 \\ α \\ {α}^{2}\end{matrix} ] ] + Re [ {\vec{V}}_{0} {\vec{I}}_{2}^{*} [ \begin{matrix}1 \\ {α}^{2} \\ α\end{matrix} ] ] = - Re [ {\vec{V}}_{1} {\vec{I}}_{2}^{*} [ \begin{matrix}1 \\ α \\ {α}^{2}\end{matrix} ] ] - Re [ {\vec{V}}_{2} {\vec{I}}_{1}^{*} [ \begin{matrix}1 \\ {α}^{2} \\ α\end{matrix} ] ] & ( 16 ) \\ {V}_{0} = \frac{( {V}_{1} {I}_{2} + {V}_{2} {I}_{1} ) sin ( {ϕ}_{1} - {ϕ}_{2} )}{{I}_{1} sin ( {ϕ}_{0} - {ϕ}_{1} ) - {I}_{2} sin ( {ϕ}_{0} - {ϕ}_{2} )} & ( 17 ) \\ {ϕ}_{0} = - arctan ( \frac{{I}_{2} sin ( - 3 {ϕ}_{1} + 3 {ϕ}_{2} )}{{I}_{1} - {I}_{2} cos ( - 3 {ϕ}_{1} + 3 {ϕ}_{2} )} ) + 2 {ϕ}_{1} - {ϕ}_{2} . & ( 18 )\end{matrix}$$

28. The method as claimed in claim 15, wherein the re-computing of the magnitude of the zero-sequence voltage comprises using the equations:
$$\begin{matrix}{\vec{V}}_{U} [ \begin{matrix}1 \\ 1 \\ 1\end{matrix} ] {\vec{V}}_{0} {e}^{jω t} + [ \begin{matrix}1 \\ {α}^{2} \\ α\end{matrix} ] {\vec{V}}_{1} {e}^{jω t} + [ \begin{matrix}1 \\ α \\ {α}^{2}\end{matrix} ] {\vec{V}}_{2} {e}^{jω t} & ( 25 ) \\ {\vec{V}}_{a} = 1 \cdot {V}_{0} {e}^{{jϕ}_{0}} + 1 \cdot {V}_{1} {e}^{{jϕ}_{1}} + 1 \cdot {V}_{2} {e}^{{jϕ}_{2}} & ( 26 ) \\ {\vec{V}}_{b} = 1 \cdot {V}_{0} {e}^{{jϕ}_{0}} + {α}^{2} \cdot {V}_{1} {e}^{{jϕ}_{1}} + α \cdot {V}_{2} {e}^{{jϕ}_{2}} & ( 27 ) \\ {\vec{V}}_{c} = 1 \cdot {V}_{0} {e}^{{jϕ}_{0}} + α \cdot {V}_{1} {e}^{{jϕ}_{1}} + {α}^{2} \cdot {V}_{2} {e}^{{jϕ}_{2}} & ( 28 ) \\ \vert {\vec{V}}_{a} \vert = \vert {V}_{0} {e}^{{jϕ}_{0}} + {V}_{1} {e}^{{jϕ}_{1}} + {V}_{2} {e}^{{jϕ}_{2}} \vert \leq {V}_{ac max} & ( 29 ) \\ {aV}_{0} \leq - ( {V}_{1} cos ( {ϕ}_{0} - {ϕ}_{1} ) + {V}_{2} cos ( {ϕ}_{0} - {ϕ}_{2} ) ) \pm & ( 30 ) \\ \sqrt{\begin{matrix}{( {V}_{1} cos ( {ϕ}_{0} - {ϕ}_{1} ) + {V}_{2} cos ( {ϕ}_{0} - {ϕ}_{2} ) )}^{2} - \\ ( {V}_{1}^{2} + {V}_{2}^{2} + 2 {V}_{1} {V}_{2} cos ( {ϕ}_{1} - {ϕ}_{2} ) - {V}_{ac max}^{2} )\end{matrix}} & ( 31 )\end{matrix}$$

29. The method as claimed in claim 16, wherein the re-computing of the magnitude of the zero-sequence voltage comprises using the equations:
$$\begin{matrix}{\vec{V}}_{U} [ \begin{matrix}1 \\ 1 \\ 1\end{matrix} ] {\vec{V}}_{0} {e}^{jω t} + [ \begin{matrix}1 \\ {α}^{2} \\ α\end{matrix} ] {\vec{V}}_{1} {e}^{jω t} + [ \begin{matrix}1 \\ α \\ {α}^{2}\end{matrix} ] {\vec{V}}_{2} {e}^{jω t} & ( 25 ) \\ {\vec{V}}_{a} = 1 \cdot {V}_{0} {e}^{{jϕ}_{0}} + 1 \cdot {V}_{1} {e}^{{jϕ}_{1}} + 1 \cdot {V}_{2} {e}^{{jϕ}_{2}} & ( 26 ) \\ {\vec{V}}_{b} = 1 \cdot {V}_{0} {e}^{{jϕ}_{0}} + {α}^{2} \cdot {V}_{1} {e}^{{jϕ}_{1}} + α \cdot {V}_{2} {e}^{{jϕ}_{2}} & ( 27 ) \\ {\vec{V}}_{c} = 1 \cdot {V}_{0} {e}^{{jϕ}_{0}} + α \cdot {V}_{1} {e}^{{jϕ}_{1}} + {α}^{2} \cdot {V}_{2} {e}^{{jϕ}_{2}} & ( 28 ) \\ \vert {\vec{V}}_{a} \vert = \vert {V}_{0} {e}^{{jϕ}_{0}} + {V}_{1} {e}^{{jϕ}_{1}} + {V}_{2} {e}^{{jϕ}_{2}} \vert \leq {V}_{ac max} & ( 29 ) \\ {aV}_{0} \leq - ( {V}_{1} cos ( {ϕ}_{0} - {ϕ}_{1} ) + {V}_{2} cos ( {ϕ}_{0} - {ϕ}_{2} ) ) \pm & ( 30 ) \\ \sqrt{\begin{matrix}{( {V}_{1} cos ( {ϕ}_{0} - {ϕ}_{1} ) + {V}_{2} cos ( {ϕ}_{0} - {ϕ}_{2} ) )}^{2} - \\ ( {V}_{1}^{2} + {V}_{2}^{2} + 2 {V}_{1} {V}_{2} cos ( {ϕ}_{1} - {ϕ}_{2} ) - {V}_{ac max}^{2} )\end{matrix}} & ( 31 )\end{matrix}$$
